(19) United States
(12) Patent Application Publication
(10) Pub. No.: US 2026/0232017 A1
(43) Pub. Date: Aug. 13, 2026

(54) AEROSOL-GENERATING ARTICLE COMPRISING AN AEROSOL-GENERATING SUBSTRATE AND CAPSULE

(71) Applicant: Philip Morris Products S.A., Neuchatel (CH)

(72) Inventors: Eva SAADE LATORRE, Colombier (CH); Jerome UTHURRY, Neuchâtel (CH)

(73) Assignee: Philip Morris Products S.A., Neuchatel (CH)

(21) Appl. No.: 19/123,275

(22) PCT Filed: Oct. 25, 2023
(86) PCT No.: PCT/EP2023/079710

§ 371 Date: Apr. 22, 2025

(30) Foreign Application Priority Data
Oct. 27, 2022 (EP) 22204241

(51) Int. Cl. A24F 40/30; A24D 1/02; A24D 1/20; A24F 40/20; A24F 40/42; A24F 40/465; H05B 3/06

(52) U.S. Cl. CPC A24F 40/30; A24D 1/02; A24D 1/20; A24F 40/20; A24F 40/42; A24F 40/465; H05B 3/06

(57) ABSTRACT

An aerosol-generating article for generating an inhalable aerosol upon heating is provided, the aerosol-generating article including: an aerosol-generating element including a first aerosol-generating substrate; and a capsule located downstream of the aerosol-generating element, the capsule containing a second aerosol-generating substrate, the second aerosol-generating substrate including nicotine, the capsule including at least one capsule air inlet located at an upstream end of the capsule, and at least one capsule air outlet located at a downstream end of the capsule, the downstream end of the capsule being at least 10 millimetres from the downstream end of the aerosol-generating article, and the first aerosol-generating substrate generating an aerosol when heated above a first temperature, and the second aerosol-generating substrate generating an aerosol when heated above a second temperature, the first temperature being higher than the second temperature.

The present invention relates to an aerosol-generating article comprising an aerosol-generating element and a capsule located downstream of the aerosol-generating element. In particular, the present invention relates to an aerosol-generating article comprising an aerosol-generating element and a capsule located downstream of the aerosol-generating element, the capsule comprising at least one capsule air inlet and at least one capsule air outlet.

Aerosol-generating articles in which an aerosol-generating substrate, such as a tobacco-containing substrate, is heated rather than combusted, are known in the art. Typically, in such heated smoking articles an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

A number of prior art documents disclose aerosol-generating devices for consuming aerosol-generating articles. Such devices include, for example, electrically heated aerosol-generating devices in which an aerosol is generated by the transfer of heat from one or more electrical heater elements of the aerosol-generating device to the aerosol-generating substrate of a heated aerosol-generating article. For example, electrically heated aerosol-generating devices have been proposed that comprise an internal heater blade which is adapted to be inserted into the aerosol-generating substrate.

Use of an aerosol-generating article in combination with an external heating system is also known. For example, WO 2020/115151 describes the provision of one or more heating elements arranged around the periphery of the aerosol-generating article when the aerosol-generating article is received in a cavity of the aerosol-generating device. As an alternative, inductively heatable aerosol-generating articles comprising an aerosol-generating substrate and a susceptor arranged within the aerosol-generating substrate have been proposed by WO 2015/176898.

The duration of the consumer experience when using known aerosol-generating articles may be determined by the amount of aerosol-generating substrate used. The amount of aerosol-generating substrate may be increased by, for example, increasing the size or the density of the aerosol-generating substrate. However, there is an upper limit to how large or dense the aerosol-generating substrate can become. A longer aerosol-generating substrate may be more difficult to heat or require longer, more powerful heaters. In addition, the provision of larger or more dense aerosol-generating substrates may increase the water content of the aerosol-generating substrate. This may increase the temperature of the aerosol, particularly during the first inhalation, during use of the aerosol-generating article containing the large or dense aerosol-generating substrate. This may further increase the power consumption requirements leading to more complex electronics needed in the device. In addition, where the aerosol-generating substrate is longer, the downstream portion of the aerosol-generating substrate may filter out a portion of the aerosol generated by the upstream portion of the aerosol-generating substrate. This is known as self-filtering and may reduce the amount of aerosol delivered to a user. Similarly, increasing the density of the aerosol-generating substrate may also require a more powerful heater and increases battery consumption and may also increase the complexity of the electronics needed in the device. In addition, a downstream portion of an aerosol-generating substrate having a higher density may disadvantageously more efficiently filter out aerosol generated further upstream in the aerosol-generating substrate.

It would therefore be desirable to provide a novel aerosol-generating article which is able to provide a user experience with a longer duration without the need to increase the complexity or the power consumption of the electronics of the associated device and while avoiding or reducing self-filtering within the aerosol-generating substrate.

The present disclosure relates to an aerosol-generating article for generating an inhalable aerosol upon heating. The aerosol-generating article may comprise an aerosol-generating element. The aerosol-generating element may comprise a first aerosol-generating substrate. The aerosol-generating article may comprise a capsule located downstream of the aerosol-generating element. The capsule may contain a second aerosol-generating substrate. The capsule may comprise at least one capsule air inlet located at the upstream end of the capsule. The capsule may comprise at least one capsule air outlet located at the downstream end of the capsule.

According to a first aspect of the present invention, there is provided an aerosol-generating article for generating an inhalable aerosol upon heating. The aerosol-generating article comprises an aerosol-generating element comprising a first aerosol-generating substrate. The aerosol-generating article comprises a capsule located downstream of the aerosol-generating element, the capsule containing a second aerosol-generating substrate. The capsule comprises at least one capsule air inlet located at the upstream end of the capsule, and at least one capsule air outlet located at the downstream end of the capsule.

The provision of an aerosol-generating article comprising both a first aerosol-generating substrate and a downstream capsule containing a second aerosol-generating substrate may advantageously allow for an extended user experience and delivery of aerosol without the technical difficulties described above. In particular, the use of a capsule to contain the second aerosol-generating substrate may allow for the use of a second aerosol-generating substrate which releases an aerosol at a lower temperature than aerosol-generating substrates of the prior art. This may advantageously allow the second aerosol-generating substrate to generate an aerosol without the need for larger, more complex heaters and electronics and without the need to increase the power consumption of the aerosol-generating device. This may advantageously mean that the size of the aerosol-generating device does not need to increase to accommodate a larger battery. It may also mean that the user may be able to use the device more times before recharging the battery of the aerosol-generating device. In addition, the provision of a capsule comprising at least one capsule air inlet and at least one air outlet may mean that the resistance to draw of the capsule is relatively low meaning the capsule does not act to filter the aerosol generated by the first aerosol-generating substrate.

Moreover, the provision of a downstream capsule containing a second aerosol-generating substrate which releases an aerosol at a lower temperature than aerosol-generating substrates of the prior art may advantageously allow the aerosol-generating article to be similar in size than aerosol-generating articles of the prior art. This may further advantageously allow the aerosol-generating article of the present invention to be used in combination with an aerosol-generating device of the prior art.

In use, the aerosol-generating article may be inserted into an aerosol-generating device and the heater of the aerosol-generating device is activated. The heater of the aerosol-generating device may be positioned to efficiently heat the first aerosol-generating substrate of the aerosol-generating element. This generates an aerosol which travels downstream along the interior of the aerosol-generating article. The aerosol from the first aerosol-generating substrate enters the capsule through the at least one capsule air inlet where the heat from the aerosol also heats the second aerosol-generating substrate indirectly by convection. The heated second aerosol-generating substrate generates a further aerosol. The aerosol from the first aerosol-generating substrate and the second aerosol-generating substrate leave the capsule through the at least one capsule air outlet and then out of the downstream end of the aerosol-generating article.

The term “aerosol-generating article” is used herein to denote an article wherein an aerosol-generating substrate is heated to produce and deliver an inhalable aerosol to a consumer. As used herein, the term “aerosol-generating substrate” denotes a substrate capable of releasing volatile compounds upon heating to generate an aerosol.

As used herein, the term “aerosol-generating device” refers to a device comprising a heater element that interacts with the aerosol-generating substrate of the aerosol-generating article to generate an aerosol.

As used herein, the term “longitudinal” refers to the direction corresponding to the main longitudinal axis of the aerosol-generating article or aerosol-generating device, which extends between the upstream and downstream ends of the aerosol-generating article or aerosol-generating device. As used herein, the terms “upstream” and “downstream” describe the relative positions of elements, or portions of elements, of the aerosol-generating article or aerosol-generating device in relation to the direction in which the aerosol is transported through the aerosol-generating article or aerosol-generating device during use.

During use, air is drawn through the aerosol-generating article in the longitudinal direction. The term “transverse” or “radial” refers to the direction that is perpendicular to the longitudinal axis. Any reference to the “cross-section” of the aerosol-generating article or a component of the aerosol-generating article refers to the transverse cross-section unless stated otherwise.

The term “length” denotes the dimension of a component of the aerosol-generating article in the longitudinal direction. For example, it may be used to denote the dimension of the rod or of the elongate tubular elements in the longitudinal direction.

The aerosol-generating element may have a diameter of at least 3 millimetres. For example, the aerosol-generating element may have a diameter of at least 4 millimetres, at least 5 millimetres, or at least 6 millimetres.

The aerosol-generating element may have a diameter of no more than 12 millimetres. For example, the aerosol-generating element may have a diameter of no more than 10 millimetres, no more than 9 millimetres, or no more than 8 millimetres.

The aerosol-generating element may have a diameter of between 3 millimetres and 12 millimetres. For example, the aerosol-generating element may have a diameter of between 3 millimetres and 10 millimetres, between 3 millimetres and 9 millimetres, or between 3 millimetres and 8 millimetres.

The aerosol-generating element may have a diameter of between 4 millimetres and 12 millimetres. For example, the aerosol-generating element may have a diameter of between 4 millimetres and 10 millimetres, between 4 millimetres and 9 millimetres, or between 4 millimetres and 8 millimetres.

The aerosol-generating element may have a diameter of between 5 millimetres and 12 millimetres. For example, the aerosol-generating substrate may have a diameter of between 5 millimetres and 10 millimetres, between 5 millimetres and 9 millimetres, or between 5 millimetres and 8 millimetres.

The aerosol-generating element may have a diameter of between 6 millimetres and 12 millimetres. For example, the aerosol-generating element may have a diameter of between 6 millimetres and 10 millimetres, between 6 millimetres and 9 millimetres, or between 6 millimetres and 8 millimetres.

The aerosol-generating element may have diameter of between 3.7 millimetres and 9 millimetres, between 5.7 millimetres and 7.9 millimetres, or between 6 millimetres and 7.5 millimetres.

In particularly preferred embodiments, the aerosol-generating element may have a diameter of less than about 7.5 millimetres. For example, the aerosol-generating element may have a diameter of about 7.2 millimetres.

In general, it has been observed that the smaller the diameter of the aerosol-generating element, the lower the temperature that is required to raise a core temperature of the first aerosol-generating substrate such that sufficient amounts of vaporizable species are released from the first aerosol-generating substrate to form a desired amount of aerosol. At the same time, without wishing to be bound by theory, it is understood that a smaller diameter of the aerosol-generating element allows for a faster penetration of heat supplied to the aerosol-generating article into the entire volume of first aerosol-generating substrate. Nevertheless, where the diameter of the aerosol-generating substrate is too small, a volume-to-surface ratio of the aerosol-generating substrate becomes less favourable, as the amount of available aerosol-generating substrate diminishes.

A diameter of the aerosol-generating element falling within the ranges described herein is particularly advantageous in terms of a balance between energy consumption and aerosol delivery. This advantage is felt in particular when an aerosol-generating article comprising an aerosol-generating element having a diameter as described herein is used in combination with an external heater arranged around the periphery of the aerosol-generating article. Under such operating conditions, it has been observed that less thermal energy is required to achieve a sufficiently high temperature at the core of the aerosol-generating substrate and, in general, at the core of the article. Thus, when operating at lower temperatures, a desired target temperature at the core of the first aerosol-generating substrate may be achieved within a desirably reduced time frame and by a lower energy consumption.

The aerosol-generating element may have a diameter that is approximately equal to the external diameter of the aerosol-generating article.

The aerosol-generating element may have a length of no more than 80 millimetres. For example, the aerosol-generating element may have a length of no more than 65 millimetres, no more than 60 millimetres, no more than 55 millimetres, no more than 50 millimetres, no more than 40 millimetres, no more than 35 millimetres, no more than 25 millimetres, no more than 20 millimetres, or no more than 15 millimetres.

The aerosol-generating element may have any length. The aerosol-generating element may have a length of at least 5 millimetres, at least 7 millimetres, at least 10 millimetres, or at least 12 millimetres.

The aerosol-generating element may have a length of between 5 millimetres and 80 millimetres. For example, the aerosol-generating element may have a length of between 5 millimetres and 65 millimetres, between 5 millimetres and 60 millimetres, between 5 millimetres and 55 millimetres, between 5 millimetres and 50 millimetres, between 5 millimetres and 40 millimetres, between 5 millimetres and 35 millimetres, between 5 millimetres and 25 millimetres, between 5 millimetres and 20 millimetres, or between 5 millimetres and 15 millimetres.

The aerosol-generating element may have a length of between 7 millimetres and 80 millimetres. For example, the aerosol-generating element may have a length of between 7 millimetres and 65 millimetres, between 7 millimetres and 60 millimetres, between 7 millimetres and 55 millimetres, between 7 millimetres and 50 millimetres, between 7 millimetres and 40 millimetres, between 7 millimetres and 35 millimetres, between 7 millimetres and 25 millimetres, between 7 millimetres and 20 millimetres, or between 7 millimetres and 15 millimetres.

The aerosol-generating element may have a length of between 5 millimetres and 80 millimetres. For example, the aerosol-generating element may have a length of between 10 millimetres and 65 millimetres, between 10 millimetres and 60 millimetres, between 10 millimetres and 55 millimetres, between 10 millimetres and 50 millimetres, between 10 millimetres and 40 millimetres, between 10 millimetres and 35 millimetres, between 10 millimetres and 25 millimetres, between 10 millimetres and 20 millimetres, or between 10 millimetres and 15 millimetres.

The aerosol-generating element may have a length of between 5 millimetres and 80 millimetres. For example, the aerosol-generating element may have a length of between 12 millimetres and 65 millimetres, between 12 millimetres and 60 millimetres, between 12 millimetres and 55 millimetres, between 12 millimetres and 50 millimetres, between 12 millimetres and 40 millimetres, between 12 millimetres and 35 millimetres, between 12 millimetres and 25 millimetres, between 12 millimetres and 20 millimetres, or between 12 millimetres and 15 millimetres.

Preferably, the aerosol-generating element may have a length of about 16 millimetres, or about 11.5 millimetres.

The provision of an aerosol-generating element having a length within the ranges set out above may prevent the upstream end of the aerosol-generating element being heated to a considerably higher temperature than the downstream end of the aerosol-generating element. This may in turn prevent less volatile components, such as aerosol former, from condensing in the downstream portion of the aerosol-generating element during use. This may advantageously help to deliver a consistent aerosol to a user which comprises the correct proportions of volatile components from the first aerosol-generating substrate.

The aerosol-generating element may have a density of no more than 1 gram per cubic centimetre. For example, the aerosol-generating element may have a density of no more than 0.5 grams per cubic centimetre, or 0.7 grams per cubic centimetre.

As used herein, the “density” of the aerosol-generating element refers to the mass of the aerosol-generating element divided by the volume taken up by the aerosol-generating element when in the aerosol-generating article. The “mass” of the aerosol-generating element includes the mass of the aerosol-generating substrate and any wrapping material circumscribing the first aerosol-generating substrate. The “volume” taken up by the aerosol-generating element includes the volume of the first aerosol-generating substrate and the volume of any wrapping material circumscribing the aerosol-generating substrate.

In preferred embodiments, the aerosol-generating element may have a density of no more than 0.45 grams per cubic centimetre, no more than 0.4 grams per cubic centimetre, no more than 0.34 grams per cubic centimetre, no more than 0.3 grams per cubic centimetre, or no more than 0.25 grams per cubic centimetre.

The aerosol-generating element may have a density of at least 0.1 grams per cubic centimetre. For example, the aerosol-generating substrate may have a density of at least 0.15 grams per cubic centimetre, at least 0.2 grams per cubic centimetre, or at least 0.24 grams per cubic centimetre.

The aerosol-generating element may have a density of between 0.1 grams per cubic centimetre and 0.45 grams per cubic centimetre. For example, the aerosol-generating element may have a density of between 0.1 grams per cubic centimetre and 0.4 grams per cubic centimetre, between 0.1 grams per cubic centimetre and 0.34 grams per cubic centimetre, between 0.1 grams per cubic centimetre and 0.3 grams per cubic centimetre, or between 0.1 grams per cubic centimetre and 0.34 grams per cubic centimetre.

The aerosol-generating element may have a density of between 0.15 grams per cubic centimetre and 0.45 grams per cubic centimetre. For example, the aerosol-generating element may have a density of between 0.15 grams per cubic centimetre and 0.4 grams per cubic centimetre, between 0.15 grams per cubic centimetre and 0.34 grams per cubic centimetre, between 0.15 grams per cubic centimetre and 0.3 grams per cubic centimetre, or between 0.15 grams per cubic centimetre and 0.34 grams per cubic centimetre.

The aerosol-generating element may have a density of between 0.2 grams per cubic centimetre and 0.45 grams per cubic centimetre. For example, the aerosol-generating element may have a density of between 0.2 grams per cubic centimetre and 0.4 grams per cubic centimetre, between 0.21 grams per cubic centimetre and 0.34 grams per cubic centimetre, between 0.2 grams per cubic centimetre and 0.3 grams per cubic centimetre, or between 0.2 grams per cubic centimetre and 0.34 grams per cubic centimetre.

The aerosol-generating element may have a density of between 0.24 grams per cubic centimetre and 0.45 grams per cubic centimetre. For example, the aerosol-generating element may have a density of between 0.24 grams per cubic centimetre and 0.4 grams per cubic centimetre, between 0.24 grams per cubic centimetre and 0.34 grams per cubic centimetre, between 0.24 grams per cubic centimetre and 0.3 grams per cubic centimetre, or between 0.24 grams per cubic centimetre and 0.34 grams per cubic centimetre.

Preferably, the aerosol-generating element may have a density of about 0.29 grams per cubic centimetre.

The capsule may comprise a capsule outer wall which defines the internal cavity that contains the aerosol-generating substrate.

The capsule outer wall may be formed of any suitable material. Preferably, the capsule outer wall is formed of an air impermeable material, most preferably an air impermeable polymeric material. This ensures that air does not pass through the capsule outer wall, other than in the holes provided specifically for airflow during use. The airflow through the capsule during use can therefore be effectively controlled.

The capsule outer wall may comprise a polymeric material or a cellulose based material. For example, the capsule outer wall may be made of one or more polymers that are compatible with nicotine, including medical grade polymers such as ALTUGLAS® Medical Resins Polymethlymethacrylate (PMMA), Chevron Phillips K-Resin® Styrene-butadiene copolymer (SBC), Arkema special performance polymers Pebax®, Rilsan®, and Rilsan® Clear, DOW (Health+™) Low-Density Polyethylene (LDPE), DOW™ LDPE 91003, DOW™ LDPE 91020 (MFI 2.0; density 923), ExxonMobil™ Polypropylene (PP) PP1013H1, PP1014H1 and PP9074MED, Trinseo CALIBRE™ Polycarbonate (PC) 2060-SERIES.

The capsule outer wall may alternatively be formed from one or more materials selected from: polyethylene (PE), polypropylene (PP), polyvinylchloride (PVC), polyethylene terephthalate (PET), polylactic acid (PLA), cellulose acetate (CA), gelatin and hydroxypropyl methyl cellulose (HPMC).

The capsule is preferably capsule shaped, in the form of a sphero-cylinder, with a cylindrical portion defined by a cylindrical wall and rounded, hemispherical end walls at each end of the cylindrical portion. This type of capsule is commonly used in the pharmaceutical industry. Alternatively, the capsule may be spherical, or ovoid.

Preferably, the capsule is a two part capsule, with two separate parts that fit together to close the capsule and retain the contents. The two separate parts may fit together by means of a friction fit, without adhesive. Alternatively, an adhesive may be used to seal the two parts together.

Preferably, the capsule comprises a first part and a second part, wherein the second part has a smaller diameter than the first part such that an end of the second part can be inserted into an open end of the first part in order to close the capsule.

In such embodiments, the outer diameters of the first part and the second part of the capsule may be adapted such that only the second part of the capsule can be received within the hollow tubular element. The outer diameter of the first part of the capsule is adapted to be larger than the inner diameter of the hollow tubular element so that the first part of the capsule cannot be received within the hollow tubular element and remains outside of the hollow tubular element. Preferably, the second part of the capsule is retained within the hollow tubular element by means of a friction fit.

Alternatively, the capsule may be fully inserted into the hollow tubular element and the outer diameters of the first part and the second part of the capsule may be adapted such that the outer diameter of the second part is smaller than the internal diameter of the hollow tubular element. This provides a space between the second part of the capsule and the wall of the hollow tubular element to enable airflow around the second part of the capsule. Such an arrangement may be beneficial in embodiments in which it is desired to position air outlets on the cylindrical wall of the capsule, as described below.

The internal cavity of the capsule has a volume of at least 250 cubic millimetres, corresponding to 0.25 millimetres. This corresponds to the internal volume of the capsule, or the capacity. Preferably, the internal cavity of the capsule has a volume of at least 400 cubic millimetres (0.4 millilitres), more preferably at least 500 cubic millimetres (0.5 millilitres), more preferably at least 600 cubic millimetres (0.6 millilitres). The internal cavity of the capsule may be less than 2000 cubic millimetres (2 millilitres), or less than 1500 cubic millimetres (1.5 millilitres) or less than 1000 cubic millimetres (1 millilitre). For example, standard capsule sizes 000, 00, 0, 0, 1, 2 and 3 may be suitable.

The capsule may have any length. The capsule may have a length of at least 10 mm. More preferably the capsule may have a length of at least 12 millimetres, more preferably at least 15 millimetres, more preferably at least 18 millimetres. The length of the capsule is preferably less than 30 millimetres, more preferably less than 28 millimetres, more preferably less than 25 millimetres. For example, the capsule length may be between 10 millimetres and 30 millimetres, or between 12 millimetres and 28 millimetres, or between 15 millimetres and 25 millimetres, or between 18 millimetres and 25 millimetres. The capsule length may be around 20 millimetres.

The capsule preferably has a maximum diameter of at least 5 millimetres, more preferably at least 5.5 millimetres, more preferably at least 6 millimetres, more preferably at least 6.5 millimetres. The maximum diameter of the capsule is preferably less than 9 millimetres, more preferably less than 8.5 millimetres, more preferably less than 8 millimetres, more preferably less than 7.5 millimetres. For example, the capsule maximum diameter may be between 5 millimetres and 9 millimetres, or between 5.5 millimetres and 8.5 millimetres, or between 6 millimetres and 6 millimetres, or between 6.5 millimetres and 7.5 millimetres. The capsule maximum diameter may be around 7 millimetres.

The ratio of the length of the capsule to the length of the aerosol-generating element may be at least 1.

For example, the ratio of the length of the capsule to the length of the aerosol-generating element may be at least 1, at least 1.25, at least 1.5, at least 1.75, at least 2, or at least 2.25.

The ratio of the length of the aerosol-generating element to the length of the capsule may be no more than 3.

It may be advantageous for the capsule to be longer than the aerosol-generating element since the first aerosol-generating substrate may have a higher density than the second aerosol-generating substrate. Where there is a need to provide a similar amount first aerosol-generating substrate as second aerosol-generating substrate, providing a longer capsule compared to the aerosol-generating element may achieve this.

For example, the ratio of the length of the capsule to the length of the aerosol-generating element may be no more than 2.75, no more than 2.5, no more than 2.25, no more than 2 or no more than 1.75.

The length of the capsule may be the same as the length of the aerosol-generating element. The length of the aerosol-generating element may be the same as the length of the capsule.

The capsule may comprise a plurality of capsule air inlets. For example, the capsule may comprise between 2 and 6 capsule air inlets.

The capsule may comprise a plurality of capsule air outlets. For example, the capsule may comprise between 2 and 6 capsule air outlets. The number of capsule air outlets may be the same as the number of capsule air inlets, or different.

The ratio of the number of capsule air inlets to the number of capsule air outlets may be greater than 0.5. For example, the ratio of the number of capsule air inlets to the number of capsule air outlets may be greater than 0.75, greater than 1, greater than 1.25, greater than 1.5, greater than 1.75, or greater than 2.

The ratio of the number of capsule air inlets to the number of capsule air outlets may be at least 1.

The ratio of the number of capsule air inlets to the number of capsule air outlets may be no more than 2. For example, the ratio of the number of capsule air inlets to the number of capsule air outlets may be no more than 1.75, no more than 1.5, no more than 1.25, no more than 1, no more than 0.75, or no more than 0.5.

It may be advantageous to provide a greater number of capsule air outlets than capsule air inlets, since the capsule air outlets need to allow the aerosol generated within the capsule to pass out of the capsule into the hollow tubular element.

It may be advantageous to provide a greater number of capsule air inlets than capsule air outlets, since doing so may force the air leaving the capsule to accelerate out of the capsule. This may reduce the pressure of air leaving the capsule promoting condensation and nucleation of aerosol.

The number and size of the capsule air inlets and capsule air outlets may be adjusted in order to control the airflow through the capsule and also the resistance to draw (RTD) of the aerosol-generating article. In certain embodiments, the capsule will provide the main source of RTD within the article and the overall RTD of the aerosol-generating article is therefore likely to be very dependent on the RTD of the capsule.

Each capsule air inlet and capsule air outlet is preferably in the form of a hole through the capsule outer wall. Preferably, each hole is spherical, although other shapes may also be suitable. The diameter of each hole should be sufficiently large that the hole cannot easily be blocked, for example, by dust. However, the diameter of each hole should also be adapted depending on the form and nature of the solid aerosol-generating substrate, so that the solid aerosol-generating substrate is not lost from the internal cavity, through the hole.

Preferably, each hole forming an air inlet or air outlet has a diameter of at least 0.2 millimetres, more preferably at least 0.25 millimetres, more preferably at least 0.3 millimetres, more preferably at least 0.35 millimetres, more preferably at least 0.4 millimetres, more preferably at least 0.5 millimetres. The diameter of each hole may be less than 2 millimetres, or less than 1.8 millimetres, or less than 1.6 millimetres, or less than 1.4 millimetres, or less than 1.2 millimetres, or less than 1 millimetre, or less than 0.9 millimetres, or less than 0.8 millimetres. For example, the diameter of each hole may be between 0.2 millimetres and 2 millimetres, or between 0.25 millimetres and 1.8 millimetres, or between 0.3 millimetres and 1.6 millimetres, or between 0.35 millimetres and 1.4 millimetres, or between 0.4 millimetres and 1.2 millimetres, or between 0.45 millimetres and 1 millimetres, or between 0.5 millimetres and 0.9 millimetres or between 0.5 millimetres and 0.8 millimetres.

Where a plurality of capsule air inlets or capsule air outlets is provided, the respective holes should be spaced apart sufficiently so that the presence of the holes does not adversely impact the structural integrity of the capsule. For example, the holes are preferably spaced at least 1 millimetre apart from each other.

The at least one capsule air outlet is preferably at least 5 millimetres downstream of the at least one air inlet, more preferably at least 8 millimetres downstream of the at least one air inlet and more preferably at least 10 millimetres downstream of the at least one air inlet. This spacing enables the length of the airflow pathway through the capsule to be maximised.

The at least one capsule air outlet is preferably positioned at the downstream end of the capsule. Where the capsule has a conventional capsule shape, with an elongate cylindrical body and rounded end walls, the at least one capsule air outlet is preferably provided on the downstream end wall.

The at least one capsule air inlet may be positioned at the upstream end of the capsule. For example, where the capsule has a conventional capsule shape as described above, the at least one capsule air inlet may be provided on the upstream end wall. However, in certain embodiments it may be advantageous to position the at least one capsule air inlet a certain distance downstream of the upstream end. For example, the at least one capsule air inlet may be provided at least 2 millimetres downstream of the upstream end of the capsule, or at least 3 millimetres downstream of the upstream end of the capsule, or at least 4 millimetres downstream of the upstream end of the capsule, or at least 5 millimetres downstream of the upstream end of the capsule. Where a plurality of capsule air inlets are provided, all of the air inlets should be provided at least this distance from the upstream end, even when the position of the capsule air inlets along the length of the capsule varies.

In preferred embodiments, the capsule comprises a cylindrical wall and rounded end walls at the upstream and downstream ends of the cylindrical wall (as in a conventional capsule shape) and the at least one capsule air inlet may advantageously be provided in the cylindrical wall, downstream of the upstream end wall.

This positioning of the at least one capsule air inlet away from the upstream end of the capsule may be particularly beneficial when the solid aerosol-generating substrate is in the form of a gel composition or any other type of substrate that melts or becomes more viscous upon heating. By the at least one capsule air inlet away from the upstream end of the cavity, where the melted substrate may collect, this ensures that the risk of the aerosol-generating substrate leaking from the capsule is minimised. The risk of blockage of the capsule air inlets by the aerosol-generating substrate is also reduced.

The at least one capsule air outlet may comprise a plurality of air outlets located at the downstream end of the capsule, the plurality of air outlets being arranged on the circumference of a circle centred on the longitudinal axis of the capsule, the circle having a diameter less than the diameter of the aerosol-generating article.

The aerosol-generating article may further comprise a hollow tubular element located downstream of the aerosol-generating element, the capsule being located in the hollow tubular element.

As used herein, the term “hollow tubular element” is used to denote a generally elongate element defining a lumen or airflow passage along a longitudinal axis thereof. In particular, the term “tubular” will be used in the following with reference to a tubular element having a substantially cylindrical cross-section and defining at least one airflow conduit establishing an uninterrupted fluid communication between an upstream end of the tubular element and a downstream end of the tubular element. However, it will be understood that alternative geometries (for example, alternative cross-sectional shapes) of the tubular element may be possible.

The hollow tubular element has the capsule containing the aerosol-generating substrate mounted at the upstream end, as described above. Further, the hollow tubular element may have a length which is greater than the length of the hollow tubular element. As a result, the hollow tubular element may define an upstream cavity upstream of the capsule, a downstream cavity downstream of the capsule, or both an upstream and a downstream cavity. In some embodiments, a downstream cavity extends from the capsule all of the way to the downstream end of the aerosol-generating article. Alternatively, one or more filter segments may be provided within the hollow tubular element, at the downstream end thereof, as described in more detail below.

The aerosol-generating element may also be disposed within the hollow tubular element. Where this is the case, the hollow tubular element may extend to the upstream end of the aerosol-generating article. This may advantageously provide structural support for the aerosol-generating article.

Where the hollow tubular element extends to the upstream end of the aerosol-generating article, the hollow tubular element preferably has a total length of at least 25 millimetres, more preferably at least 28 millimetres, more preferably at least 30 millimetres, more preferably at least 32 millimetres, more preferably at least 34 millimetres. The length of the hollow tubular element may be less than 50 millimetres, or less than 48 millimetres, or less than 45 millimetres, or less than 42 millimetres or less than 40 millimetres. For example, the total length of the hollow tubular element may be between 25 millimetres and 50 millimetres, or between 28 millimetres and 48 millimetres, or between 30 millimetres and 45 millimetres, or between 32 millimetres and 42 millimetres, or between 34 millimetres and 40 millimetres.

The hollow tubular element downstream of the aerosol-generating element preferably has a length of at least 10 millimetres, more preferably at least 12 millimetres and more preferably at least 14 millimetres. The length of the hollow tubular element downstream of the aerosol-generating element may be up to 40 millimetres, or up to 30 millimetres, or up to 25 millimetres. For example, the hollow tubular element downstream of the aerosol-generating element may have a length of between 10 millimetres and 40 millimetres, or between 12 millimetres and 30 millimetres, or between 14 millimetres and 25 millimetres.

The capsule may extend to the downstream end of the aerosol-generating article. Where this is the case, the downstream end of the capsule may be aligned with the downstream end of the aerosol-generating article.

The capsule may not extend to the downstream end of the aerosol-generating article. Where this is the case, the downstream end of the capsule may be spaced apart from the downstream end of the aerosol-generating article. For example, the downstream end of the capsule may be at least 2 millimetres, at least 5 millimetres, at least 10 millimetres, at least 15 millimetres, at least 20 millimetres, or at least 25 millimetres from the downstream end of the aerosol-generating article.

Spacing the capsule from the downstream end of the aerosol-generating article may advantageously allow the capsule to be heated at least to some extend by the aerosol-generating device when the aerosol-generating article is in use. Where the capsule extends to the downstream end of the aerosol-generating article, at least a portion of the capsule will be close to the lips of a user. This means that the capsule cannot be directly heated by the aerosol-generating device, and the temperature it is heated to must be limited to avoid discomfort to a user.

Alternatively, the aerosol-generating element may be disposed upstream of the upstream end of the hollow tubular element. This may advantageously allow the first aerosol-generating substrate to be heated more readily where the article is used in combination with an external heater since the heat does not need to penetrate the hollow tubular element.

An upstream end of the hollow tubular element may abut a downstream end of the aerosol-generating element.

Where the aerosol-generating element may be disposed upstream of the upstream end of the hollow tubular element, the hollow tubular element preferably has a total length of at least 10 millimetres, more preferably at least 12 millimetres and more preferably at least 14 millimetres. The length of the hollow tubular element may be up to 40 millimetres, or up to 30 millimetres, or up to 25 millimetres. For example, the hollow tubular element may have a length of between 10 millimetres and 40 millimetres, or between 12 millimetres and 30 millimetres, or between 14 millimetres and 25 millimetres.

The hollow tubular element may have an outer diameter of between 5 millimetres and 12 millimetres, for example of between 5 millimetres and 10 millimetres or of between 6 millimetres and 8 millimetres. In a preferred embodiment, the hollow tubular element has an external diameter of 7.2 millimetres plus or minus 10 percent.

The internal diameter of the hollow tubular element is preferably constant along the length of the hollow tubular element. The lumen or cavity of the hollow tubular segment may have any cross sectional shape. The lumen of the hollow tubular segment may have a circular cross sectional shape.

Preferably, the internal diameter of the hollow tubular element is at least 5 millimetres, more preferably at least 5.5 millimetres, more preferably at least 6 millimetres, more preferably at least 6.5 millimetres. The internal diameter of the hollow tubular element is preferably less than 9 millimetres, more preferably less than 8.5 millimetres, more preferably less than 8 millimetres, more preferably less than 7.5 millimetres. For example, the internal diameter may be between 5 millimetres and 9 millimetres, or between 5.5 millimetres and 8.5 millimetres, or between 6 millimetres and 6 millimetres, or between 6.5 millimetres and 7.5 millimetres. The internal diameter may be around 7 millimetres.

The hollow tubular element preferably has a wall thickness of at least 100 micrometres, more preferably at least 150 micrometres, more preferably at least 200 micrometres, more preferably at least 250 micrometres, more preferably at least 500 micrometres. The wall thickness of the hollow tubular element may be less than 2 millimetres, preferably less than 1.5 millimetres and even more preferably less than 1.25 mm. The wall thickness of the hollow tubular element may be less than 1 millimetre. For example, the wall thickness of the hollow tubular element may be between 100 micrometres and 2 millimetres, or between 150 micrometres and 1.5 millimetres, or between 200 micrometres and 1.25 millimetres, or between 250 micrometres and 1 millimetre, or between 500 micrometres and 1 millimetre.

The hollow tubular segment may comprise a paper-based material. The hollow tubular segment may comprise at least one layer of paper. The paper may be very rigid paper. The paper may be crimped paper, such as crimped heat resistant paper or crimped parchment paper. Advantageously, a crimped paper may form one or more airflow channels extending around the outside of the capsule. The one or more airflow channels may be particularly advantageous in embodiments in which the capsule comprises at least one of an air inlet and an air outlet on a cylindrical wall of the capsule.

Preferably, the hollow tubular element is formed from cardboard. The hollow tubular element may be a cardboard tube. Advantageously, cardboard is a cost-effective material that provides a balance between being deformable in order to provide ease of insertion of the article into an aerosol-generating device and being sufficiently stiff to provide suitable engagement of the article with the interior of the device. A cardboard tube may therefore provide suitable resistance to deformation or compression during use.

The hollow tubular segment may be a paper tube. The hollow tubular segment may be a tube formed from spirally wound paper. The hollow tubular segment may be formed from a plurality of layers of the paper. The paper may have a basis weight of at least about 50 grams per square meter, at least about 60 grams per square meter, at least about 70 grams per square meter, or at least about 90 grams per square meter.

The hollow tubular segment may comprise a polymeric material. For example, the hollow tubular segment may comprise a polymeric film. The polymeric film may comprise a cellulosic film. The hollow tubular segment may comprise low density polyethylene (LDPE) or polyhydroxyalkanoate (PHA) fibres. The hollow tube may comprise cellulose acetate tow.

Where the hollow tubular segment comprises cellulose acetate tow, the cellulose acetate tow may have a denier per filament of between about 2 and about 4 and a total denier of between about 25 and about 40.

The capsule may be disposed within a capsule section of the hollow tubular element. The capsule section may extend from the downstream end of the aerosol-generating element to either the downstream end of the aerosol-generating article, or where present the upstream end of a mouthpiece filter.

The length of the capsule section may be greater than the length of the capsule. The ratio of the length of the capsule section to the length of the capsule may be at least 1.05, at least 1.1, at least 1.3, or at least 1.5.

The ratio of the length of the capsule section to the length of the capsule may be no more than 2.5, no more than 2.2, no more than 2, no more than 1.8.

Where the length of the capsule section is greater than the length of the capsule, the capsule may be located substantially equidistant between the upstream and the downstream end of the capsule section. As described above, this arrangement may result in an empty cavity upstream and downstream of the capsule. The empty cavity upstream and downstream of the capsule may act to cool the vapours generated by the first and second aerosol-generating substrates. This may advantageously promote the condensation and nucleation of aerosols promoting aerosol generation.

The hollow tubular element may comprise at least one stop such as a flange or protrusion extending inwards from the internal surface at the downstream end of the capsule, to prevent the capsule from being pushed downstream further into the hollow tubular element. For example, the hollow tubular element may comprise an annular flange extending from the internal surface.

The hollow tubular element may comprise both an upstream and a downstream stop, such as an upstream flange and a downstream flange to prevent the capsule from moving longitudinally within the capsule section of the hollow tubular element.

The hollow tubular element may comprise a first ventilation zone. The first ventilation zone may be provided downstream of the downstream end of the aerosol-generating element but upstream of the upstream end of the capsule.

The hollow tubular element may comprise a second ventilation zone. The second ventilation zone may be provided downstream of the downstream end of the capsule.

The provision of a first ventilation zone may allow ambient air to be drawn into the hollow tubular element immediately downstream of the aerosol-generating element. The provision of ambient air may promote aerosol generation from the first aerosol-generating substrate.

The upstream end of the first ventilation zone may be located no more than 10 millimetres from the downstream end of the aerosol-generating element.

The provision of a second ventilation zone may allow ambient air to be drawn into the hollow tubular element immediately downstream of the capsule. The provision of ambient air may promote aerosol generation from the second aerosol-generating substrate.

The upstream end of the second ventilation zone may be located no more than 10 millimetres from the downstream end of the capsule.

Features of “the ventilation zone” described below refers to optional features of either the first ventilation zone or the second ventilation zone, or both the first and second ventilation zones.

The ventilation zone may comprise at least one ventilation perforation. The ventilation zone may comprise a plurality of ventilation perforations through the hollow tubular element. The ventilation zone may comprise at least 2 ventilation perforations. For example, the ventilation zone may comprise at least 2, at least 3, at least 5, or at least 10 ventilation perforations through the hollow tubular element.

The provision of a greater number of ventilation perforations than this may advantageously improve the generation of aerosol.

The ventilation zone may comprise no more than 35 ventilation perforations. For example, the ventilation zone may comprise no more than 30, no more than 25, no more than 20, or no more than 15 ventilation perforations through the hollow tubular element.

The plurality of ventilation perforations may comprise at least one perforation having a width of no more than 200 micrometres. For example, the plurality of ventilation perforations may comprise at least one perforation having a width of no more than 175 micrometres, no more than 150 micrometres, no more than 125 micrometres, or no more than 120 micrometres.

The plurality of ventilation perforations may comprise at least one perforation having a width of no more than 2 millimetres. For example, the plurality of ventilation perforations may comprise at least one perforation having a width of no more than 1.5 millimetres, no more than 1 millimetre, no more than 500 micrometres, or no more than 250 micrometres.

The plurality of ventilation perforations may comprise at least one perforation having a width of at least 50 micrometres. The plurality of ventilation perforations may comprise at least one perforation having a width of at least 50 micrometres. For example, the plurality of ventilation perforations may comprise at least one perforation having a width of at least 65 micrometres, at least 80 micrometres, at least 90 micrometres, or at least 100 micrometres. The plurality of ventilation perforations may comprise at least one perforation having a length of at least 400 micrometres. The plurality of ventilation perforations may comprise at least one perforation having a length of no more than 1 millimetres. The plurality of ventilation perforations may form a line of perforations which circumscribes the hollow tubular element. The ventilation zone may comprise a porous portion of the hollow tubular element.

The ventilation level of the aerosol-generating article provided by the ventilation zone may be at least 20 percent.

The aerosol-generating article may further comprise at least one capsule downstream stop protruding from the inner surface of the hollow tubular element to prevent the capsule from moving further downstream than the at least one capsule downstream stop.

The provision of the at least one capsule downstream stop may advantageously help to retain the capsule in place within the hollow tubular element. In particular, the at least one capsule downstream stop may advantageously prevent the capsule from moving too far downstream where it may occlude the ventilation zone preventing ambient air entering the hollow tubular element.

The at least one capsule downstream stop may be located upstream of the ventilation zone.

The at least one capsule downstream stop may be any type of stop. The at least one capsule downstream stop may restrict the inner diameter of the hollow tubular element at a point. The inner diameter of the hollow tubular element at the at least one capsule downstream stop may be less than the outer diameter of the capsule thereby preventing the capsule from moving any further downstream than the at least one capsule downstream stop.

The at least one capsule downstream stop may comprise an embossed potion of the hollow tubular element extending into the interior of the hollow tubular element.

The at least one capsule downstream stop may comprise a thicker portion of the hollow tubular element which reduces the inner diameter of the hollow tubular element to prevent the capsule from moving any further downstream than the thicker portion.

The at least one capsule downstream stop may comprise a flange within and attached to the hollow tubular element which prevents the capsule from moving further downstream.

The aerosol-generating article may further comprise at least one capsule upstream stop protruding from the inner surface of the hollow tubular element to prevent the capsule from moving further upstream than the at least one capsule upstream stop.

The features of the at least one capsule downstream stop described above may be equally applicable to the at least one capsule upstream stop.

The aerosol-generating article may further comprise a wrapper circumscribing at least a downstream portion of the aerosol-generating element and an upstream portion of the hollow tubular element.

Where the hollow tubular element does not extend further upstream than the upstream end of the capsule section of the hollow tubular element, the provision of a wrapper may advantageously attach the aerosol-generating element to the hollow tubular element. The wrapper may circumscribe the entire length of the aerosol-generating element. This may advantageously provide greater strength and a more secure connection between the aerosol-generating element and the hollow tubular element.

The wrapper may be attached to one or more of the aerosol-generating element and the hollow tubular element by an adhesive applied between the wrapper and one or more of the aerosol-generating element and the hollow tubular element.

The aerosol-generating article may further comprise a heat conducting element to transfer heat from the aerosol-generating element to the capsule.

The provision of a heat conducting element may advantageously allow heat from the aerosol-generating element, which may be directly heated by a heater of an aerosol-generating device, to be efficiently transferred by conduction to the capsule. This may advantageously improve the aerosol generation by the second aerosol-generating substrate.

The heat conducting element may comprise a heat conducting material.

As used herein with reference to the present invention, the term “heat conducting material” is used to describe a material having a bulk thermal conductivity of at least about 10 W per metre Kelvin (W/(m K)) at 23° C. and a relative humidity of 50% as measured using the modified transient plane source (MTPS) method.

The heat conducting element may comprise a metal. For example, the heat conducting body may comprise at least one of aluminium, steel, Nimmonic, and Inconel. Preferably the heat conducting element comprises aluminium.

The heat conducting element may be provided within the hollow tubular element. The heat conducting element may be provided on the outer surface of the hollow tubular element.

The heat conducting element may comprise a portion of the wrapper formed from a heat conducting material.

The heat conducting element may comprise a metallic foil circumscribing at least a portion of the aerosol-generating element and a portion of the capsule.

The heat conducting element may comprise a rod or a pin of heat conducting material extending from the aerosol-generating element to the capsule. The heat conducting element may extend into the capsule.

The external diameter of the capsule may be approximately the same as the inner diameter of the hollow tubular element such that air is unable to pass from the upstream end of the hollow tubular element to the downstream end of the hollow tubular element without passing through the capsule.

In this way, air is substantially prevented from passing from the upstream end of the hollow tubular element to the downstream end of the hollow tubular element without passing through the capsule.

Without wishing to be bound by theory, it is anticipated that the airflow through the aerosol-generating article will significantly slow down once the air exits the capsule through the at least one capsule air outlet and enters the interior of the hollow tubular element. This is because the diameter of the hollow tubular element is greater than the diameter of the at least one capsule air outlet. This slowing down of the airflow also results is a pressure decrease which may additionally facilitate desirable nucleation of the aerosol. In addition, the slowing down of the airflow may also improve the cooling of the airflow by the ambient air entering through the ventilation zone. This may further advantageously facilitate aerosol generation.

The internal cavity of the capsule preferably contains at least 50 milligrams of the second aerosol-generating substrate, more preferably at least 100 milligrams of the second aerosol-generating substrate, more preferably at least 150 milligrams of the second aerosol-generating substrate. The internal cavity may contain up to 1000 milligrams of the second aerosol-generating substrate, or up to 750 milligrams of the second aerosol-generating substrate, or up to 500 milligrams of the second aerosol-generating substrate, or up to 250 milligrams of the second aerosol-generating substrate. For example, the internal cavity of the capsule may contain between 50 milligrams and 1000 milligrams of the second aerosol-generating substrate, or between 100 milligrams and 750 milligrams of the second aerosol-generating substrate, or between 150 milligrams and 500 milligrams of the second aerosol-generating substrate, or between 150 milligrams and 250 milligrams of the second aerosol-generating substrate.

According to the invention, the density of the second aerosol-generating substrate within the capsule corresponds to at least 0.1 milligrams per cubic millimetre of the internal cavity. This corresponds to the total weight of the second aerosol-generating substrate, divided by the total volume of the internal cavity. Preferably, the density of the second aerosol-generating substrate within the capsule corresponds to at least 0.12 milligrams per cubic millimetre of the internal cavity, more preferably at least 0.15 milligrams per cubic millimetre of the internal cavity, more preferably at least 0.18 milligrams per cubic millimetre of the internal cavity, more preferably at least 0.2 milligrams per cubic millimetre more preferably at least 0.22 milligrams per cubic millimetre, more preferably at least 0.25 milligrams per cubic millimetre, more preferably at least 0.28 milligrams per cubic millimetre, more preferably at least 0.3 milligrams per cubic millimetre, more preferably at least 0.32 milligrams per cubic millimetre, more preferably at least 0.35 milligrams per cubic millimetre, more preferably at least 0.38 milligrams per cubic millimetre, more preferably at least 0.4 milligrams per cubic millimetre. Preferably, the density of the second aerosol-generating substrate within the capsule corresponds to less than 2 milligrams per cubic millimetre of the internal cavity, more preferably less than 1.9 milligrams per cubic millimetre, more preferably less than 1.8 milligrams per cubic millimetre, more preferably less than 1.7 milligrams per cubic millimetre, more preferably less than 1.6 milligrams per cubic millimetre, more preferably less than 1.5 milligrams per cubic millimetre, more preferably less than 1.4 milligrams per cubic millimetre, more preferably less than 1.3 milligrams per cubic millimetre, more preferably less than 1.2 milligrams per cubic millimetre, more preferably less than 1.1 milligrams per cubic millimetre, more preferably less than 1 milligram per cubic millimetre of the internal cavity. For example, the density of the second aerosol-generating substrate within the capsule may correspond to between 0.1 milligrams per cubic millimetre and 2 milligrams per cubic millimetre of the internal cavity, or between 0.12 milligrams per cubic millimetre and 1.9 milligrams per cubic millimetre of the internal cavity, or between 0.15 milligrams per cubic millimetre and 1.8 milligrams per cubic millimetre of the internal cavity, or between 0.18 milligrams per cubic millimetre and 1.7 milligrams per cubic millimetre of the internal cavity, or between 0.2 milligrams per cubic millimetre and 1.6 milligrams per cubic millimetre of the internal cavity, or between 0.22 milligrams per cubic millimetre and 1.5 milligrams per cubic millimetre of the internal cavity, or between 0.25 milligrams per cubic millimetre and 1.4 milligrams per cubic millimetre of the internal cavity, or between 0.28 milligrams per cubic millimetre and 1.3 milligrams per cubic millimetre of the internal cavity, or between 0.3 milligrams per cubic millimetre and 1.2 milligrams per cubic millimetre of the internal cavity, or between 0.32 milligrams per cubic millimetre and 1.1 milligrams per cubic millimetre of the internal cavity, or between 0.35 milligrams per cubic millimetre and 1 milligrams per cubic millimetre of the internal cavity, or between 0.38 milligrams per cubic millimetre and 1 milligrams per cubic millimetre of the internal cavity, or between 0.4 milligrams per cubic millimetre and 1 milligrams per cubic millimetre of the internal cavity.

The percentage fill of the capsule by the second aerosol-generating substrate is preferably at least 50 percent, more preferably at least 60 percent, more preferably at least 70 percent. The percentage fill is preferably less than 90 percent. The percentage fill corresponds to the percentage of the internal cavity of the capsule that is occupied by the second aerosol-generating substrate. It may be advantageous to retain some empty space within the internal cavity to allow for air flow through the internal cavity and for the second aerosol-generating substrate to be heated evenly.

The first aerosol-generating substrate and the second aerosol-generating substrate may be configured to generate a first and second aerosol respectively when heated.

The first aerosol and the second aerosol may be the same aerosol. The first aerosol and the second aerosol may be different aerosols.

The temperature at which the second aerosol-generating substrate generates an aerosol may be lower than the temperature at which the first aerosol-generating substrate generates an aerosol.

The first aerosol-generating substrate may generate an aerosol when the first aerosol-generating substrate is heated above a first temperature. The second aerosol-generating substrate may generate an aerosol when the second aerosol-generating substrate is heated above a second temperature.

The first temperature may be higher than the first temperature. For example, the first temperature may be at least 5 degrees Celsius, at least 10 degrees Celsius, at least 20 degrees Celsius, at least 30 degrees Celsius, or at least 50 degrees Celsius higher than the second temperature.

The first and second temperatures may both be higher than ambient temperature. The first and second temperatures may both be higher than room temperature. The first and second temperatures may both be higher than 20 degrees Celsius, 30 degrees Celsius, 35 degrees Celsius, 40 degrees Celsius, 50 degrees Celsius, 60 degrees Celsius, or 100 degrees Celsius. The second temperature may be higher than ambient temperature. For example, the second temperature may be higher than 20 degrees Celsius, 30 degrees Celsius, 35 degrees Celsius, 40 degrees Celsius, 50 degrees Celsius, 60 degrees Celsius, or 100 degrees Celsius.

As described above, this may advantageously allow for efficient aerosol generation by the second aerosol-generating substrate even when the second aerosol-generating substrate is not directly heated by a heater of an aerosol-generating device.

The aerosol-generating article may further comprise a downstream filter segment located downstream of the capsule, the downstream filter segment comprising filter material.

Where the hollow tubular element extends to the downstream end of the aerosol-generating article, the downstream filter segment may comprise a segment of filter material mounted within the hollow tubular element at the downstream end of the hollow tubular segment.

Where this is the case, the segment of filter material preferably has an external diameter that is approximately equal to the internal diameter of the hollow tubular element, so that the segment of filter material is retained within the hollow tubular element by means of a friction fit.

Preferably, the external diameter of the downstream filter segment is between 5 millimetres and 12 millimetres, more preferably between 6 millimetres and 10 millimetres, more preferably between 7 millimetres and 8 millimetres.

The filter segment may extend to the downstream end of the hollow tubular element.

The downstream end of the downstream filter segment may define the downstream end of the aerosol-generating article. The inclusion of a downstream filter segment may be useful in order to provide a desired level of RTD for the aerosol-generating article.

The filter material of the downstream filter segment is preferably a solid plug, which may also be described as a ‘plain’ plug and is non-tubular. The filter material therefore preferably has a substantially uniform transverse cross section.

The filter material is preferably formed of a fibrous filtration material. The fibrous filtration material may be for filtering the aerosol that is generated from the first and second aerosol-generating substrates. Suitable fibrous filtration materials would be known to the skilled person. Particularly preferably, the filter material comprises cellulose acetate tow.

The downstream filter segment may optionally comprise a flavourant, which may be provided in any suitable form. For example, the downstream filter segment may comprise one or more capsules, beads or granules of a flavourant, or one or more flavour loaded threads or filaments.

Preferably, the downstream filter segment has a low particulate filtration efficiency.

Unless otherwise specified, the resistance to draw (RTD) of a component or the aerosol-generating article is measured in accordance with ISO 6565-2015. The RTD refers the pressure required to force air through the full length of a component. The terms “pressure drop” or “draw resistance” of a component or article may also refer to the “resistance to draw”. Such terms generally refer to the measurements in accordance with ISO 6565-2015 are normally carried out at under test at a volumetric flow rate of 17.5 millilitres per second at the output or downstream end of the measured component at a temperature of 22 degrees Celsius, a pressure of 101 kPa (about 760 Torr) and a relative humidity of 60%. Conditions for smoking and smoking machine specifications are set out in ISO Standard 3308 (ISO 3308:2000). Atmosphere for conditioning and testing are set out in ISO Standard 3402 (ISO 3402:1999).

The resistance to draw (RTD) of the downstream filter segment may be at least 0 millimetres H₂O, or at least 3 millimetres H₂O, or at least 6 millimetres H₂O.

The RTD of the downstream filter segment may be no greater than 12 millimetres H₂O, or no greater than 11 millimetres H₂O, or no greater than 10 millimetres H₂O.

As mentioned above, the downstream filter segment may be formed of a fibrous filtration material. The downstream filter segment may be formed of a porous material. The downstream filter segment may be formed of a biodegradable material. The downstream filter segment may be formed of a cellulose material, such as cellulose acetate. For example, a downstream filter segment may be formed from a bundle of cellulose acetate fibres having a denier per filament between 10 and 15. For example, a downstream filter segment formed from relatively low density cellulose acetate tow, such as cellulose acetate tow comprising fibres of 12 denier per filament.

The downstream filter segment may be formed of a polylactic acid based material. The downstream filter segment may be formed of a bioplastic material, preferably a starch-based bioplastic material. The downstream filter segment may be made by injection moulding or by extrusion. Bioplastic-based materials are advantageous because they are able to provide downstream filter segment structures which are simple and cheap to manufacture with a particular and complex cross-sectional profile, which may comprise a plurality of relatively large air flow channels extending through the downstream filter segment material, which provides suitable RTD characteristics.

The length of the downstream filter segment may be at least 5 millimetres, or at least 8 millimetres, or at least 10 millimetres. The length of the downstream filter segment may be less than 20 millimetres, or less than 15 millimetres, or less than 12 millimetres. For example, the length of the downstream filter segment may be between 5 millimetres and 20 millimetres, or between 8 millimetres and 15 millimetres, or between 8 millimetres and 12 millimetres, or between 10 millimetres and 12 millimetres.

In alternative embodiments of the present invention, a downstream filter segment may be provided downstream of the hollow tubular element. The downstream filter segment may extend between the hollow tubular element and the downstream end of the aerosol-generating article. In such embodiments, the downstream filter segment may be connected to the hollow tubular element by means of a tipping wrapper.

The overall RTD of the aerosol-generating article may be at least 1 millimetre H₂O. For example, the overall RTD of the aerosol-generating article may be at least 2 millimetres H₂O, at least 3 millimetres H₂O, at least 4 millimetres H₂O, at least 5 millimetres H₂O, at least 6 millimetres H₂O, at least 7 millimetres H₂O, at least 8 millimetres H₂O, at least 9 millimetres H₂O, at least 10 millimetres H₂O, at least 15 millimetres H₂O, at least 20 millimetres H₂O, at least 30 millimetres H₂O, at least 40 millimetres H₂O, or at least 50 millimetres H₂O.

The overall RTD of the aerosol-generating article may be no more than 180 millimetres H₂O. For example, the overall RTD of the aerosol-generating article may be no more than 170 millimetres H₂O, no more than 160 millimetres H₂O, no more than 150 millimetres H₂O, or no more than 140 millimetres H₂O.

The overall RTD of the aerosol-generating article may be between 1 millimetre H₂O and 180 millimetres H₂O. For example, the overall RTD of the aerosol-generating article may be between 5 millimetres H₂O and 170 millimetres H₂O, between 10 millimetres H₂O and 160 millimetres H₂O, between 20 millimetres H₂O and 150 millimetres H₂O, or between 50 millimetres H₂O and 140 millimetres H₂O.

The aerosol-generating article in accordance with the invention may have an overall length of at least 40 millimetres, or at least 50 millimetres, or at least 60 millimetres.

An overall length of an aerosol-generating article in accordance with the invention may be less than or equal to 90 millimetres, or less than or equal to 85 millimetres, or less than or equal to 80 millimetres.

In some embodiments, an overall length of the aerosol-generating article is preferably from 40 millimetres to 70 millimetres, more preferably from 45 millimetres to 70 millimetres. In other embodiments, an overall length of the aerosol-generating article is preferably from 40 millimetres to 60 millimetres, more preferably from about 45 millimetres to about 60 millimetres. In further embodiments, an overall length of the aerosol-generating article is preferably from 40 millimetres to 50 millimetres, more preferably from 45 millimetres to 50 millimetres. In an exemplary embodiment, an overall length of the aerosol-generating article is about 45 millimetres.

The aerosol-generating article may have an external diameter of at least 5 millimetres, or at least 6 millimetres, or at least 7 millimetres.

The aerosol-generating article may have an external diameter of less than or equal to about 12 millimetres, or less than or equal to about 10 millimetres, or less than or equal to about 8 millimetres.

In some embodiments, the aerosol-generating article has an external diameter from about 5 millimetres to about 12 millimetres, preferably from about 6 millimetres to about 12 millimetres, more preferably from about 7 millimetres to about 12 millimetres. In other embodiments, the aerosol-generating article has an external diameter from about 5 millimetres to about 10 millimetres, preferably from about 6 millimetres to about 10 millimetres, more preferably from about 7 millimetres to about 10 millimetres. In further embodiments, the aerosol-generating article has an external diameter from about 5 millimetres to about 8 millimetres, preferably from about 6 millimetres to about 8 millimetres, more preferably from about 7 millimetres to about 8 millimetres. In other embodiments, the aerosol-generating article has an external diameter of less than 7 millimetres.

The external diameter of the aerosol-generating article may be substantially constant over the whole length of the article. As an alternative, different portions of the aerosol-generating article may have different external diameters.

The aerosol-generating element may further comprise a susceptor element.

As used herein, the term “susceptor element” refers to an element comprising a material that is capable of converting electromagnetic energy into heat. When a susceptor element is located in an alternating electromagnetic field, the susceptor is heated. Heating of the susceptor element may be the result of at least one of hysteresis losses and eddy currents induced in the susceptor, depending on the electrical and magnetic properties of the susceptor material. Aerosol-generating articles according to the present invention may be used with aerosol-generating devices which include an inductive coil for inducing a current in the corresponding susceptor element in the aerosol-generating element.

A susceptor element may be arranged such that, when the aerosol-generating article is received in the cavity of the aerosol-generating device, the oscillating electromagnetic field generated by the inductor coil induces a current in the susceptor element, causing the susceptor element to heat up. In these embodiments, the aerosol-generating device is preferably capable of generating a fluctuating electromagnetic field having a magnetic field strength (H-field strength) of between 1 and 5 kilo amperes per metre (kA m), preferably between 2 and 3 kA/m, for example about 2.5 kA/m. The electrically-operated aerosol-generating device is preferably capable of generating a fluctuating electromagnetic field having a frequency of between 1 and 30 MHz, for example between 1 and 10 MHz, for example between 5 and 7 MHz.

The susceptor element is preferably located in contact with the first aerosol-generating substrate. The susceptor element may be located within the first aerosol-generating substrate.

In some embodiments, the susceptor element is arranged to heat the outer surface of the first aerosol-generating substrate. In some embodiments, the susceptor element is arranged for insertion into the first aerosol-generating substrate when the aerosol-generating substrate is received within the cavity.

The susceptor element may comprise any suitable material. The susceptor element may be formed from any material that can be inductively heated to a temperature sufficient to release volatile compounds from the aerosol-generating substrate. Suitable materials for the elongate susceptor element include graphite, molybdenum, silicon carbide, stainless steels, niobium, aluminium, nickel, nickel containing compounds, titanium, and composites of metallic materials. Some susceptor elements comprise a metal or carbon. Advantageously the susceptor element may comprise or consist of a ferromagnetic material, for example, ferritic iron, a ferromagnetic alloy, such as ferromagnetic steel or stainless steel, ferromagnetic particles, and ferrite. A suitable susceptor element may be, or comprise, aluminium. The susceptor element preferably comprises more than about 5 percent, preferably more than about 20 percent, more preferably more than about 50 percent or more than about 90 percent of ferromagnetic or paramagnetic materials. Some elongate susceptor elements may be heated to a temperature in excess of about 250 degrees Celsius.

The susceptor element may comprise a non-metallic core with a metal layer disposed on the non-metallic core. For example, the susceptor element may comprise metallic tracks formed on an outer surface of a ceramic core or substrate.

The susceptor element may extend the full length of the aerosol-generating element.

In other words, the upstream end of the susceptor element may be aligned with the upstream end of the aerosol-generating element and the downstream end of the susceptor element may be aligned with the downstream end of the aerosol-generating element.

The provision of a susceptor element which extends the full length of the aerosol-generating element may advantageously ensure maximum aerosol generation of the first aerosol-generating substrate.

The first aerosol-generating substrate may be a solid aerosol-generating substrate.

The first aerosol-generating substrate may comprise homogenised plant material. The first aerosol-generating substrate may comprise tobacco. The first aerosol-generating substrate may comprise a homogenised tobacco material.

As used herein, the term “homogenised plant material” encompasses any plant material formed by the agglomeration of particles of plant. For example, sheets or webs of homogenised tobacco material for the aerosol-generating substrates of the present invention may be formed by agglomerating particles of tobacco material obtained by pulverising, grinding or comminuting plant material and optionally one or more of tobacco leaf lamina and tobacco leaf stems. The homogenised plant material may be produced by casting, extrusion, paper making processes or other any other suitable processes known in the art.

The homogenised plant material can be provided in any suitable form.

The homogenised plant material may be in the form of one or more sheets. As used herein with reference to the invention, the term “sheet” describes a laminar element having a width and length substantially greater than the thickness thereof.

The homogenised plant material may be in the form of a plurality of pellets or granules.

The homogenised plant material may be in the form of a plurality of strands, strips or shreds. As used herein, the term “strand” describes an elongate element of material having a length that is substantially greater than the width and thickness thereof. The term “strand” should be considered to encompass strips, shreds and any other homogenised plant material having a similar form. The strands of homogenised plant material may be formed from a sheet of homogenised plant material, for example by cutting or shredding, or by other methods, for example, by an extrusion method.

In some embodiments, the strands may be formed in situ within the first aerosol-generating substrate as a result of the splitting or cracking of a sheet of homogenised plant material during formation of the aerosol-generating substrate, for example, as a result of crimping. The strands of homogenised plant material within the first aerosol-generating substrate may be separate from each other. Alternatively, each strand of homogenised plant material within the first aerosol-generating substrate may be at least partially connected to an adjacent strand or strands along the length of the strands. For example, adjacent strands may be connected by one or more fibres. This may occur, for example, where the strands have been formed due to the splitting of a sheet of homogenised plant material during production of the aerosol-generating substrate, as described above.

Where the first aerosol-generating substrate comprises a homogenised plant material, the homogenised plant material may typically be provided in the form of one or more sheets. In particular, sheets of homogenised plant material may be produced by a casting process. Preferably, sheets of homogenised plant material may be produced by a paper-making process.

The first aerosol-generating substrate may comprise cut filler. The first aerosol-generating substrate may comprise tobacco cut filler.

As used herein, the term “cut filler” is used to describe to a blend of shredded plant material, such as tobacco plant material, including, in particular, one or more of leaf lamina, processed stems and ribs, homogenised plant material.

The cut filler may also comprise other after-cut, filler tobacco or casing.

Preferably, the cut filler comprises at least 25 percent of plant leaf lamina, more preferably, at least 50 percent of plant leaf lamina, still more preferably at least 75 percent of plant leaf lamina and most preferably at least 90 percent of plant leaf lamina. Preferably, the plant material is one of tobacco, mint, tea and cloves. However, as will be discussed below in greater detail, the invention is equally applicable to other plant material that has the ability to release substances upon the application of heat that can subsequently form an aerosol.

Preferably, the cut filler comprises tobacco plant material comprising lamina of one or more of bright tobacco, dark tobacco, aromatic tobacco and filler tobacco. With reference to the present invention, the term “tobacco” describes any plant member of the genus Nicotiana. Bright tobaccos are tobaccos with a generally large, light coloured leaves. Throughout the specification, the term “bright tobacco” is used for tobaccos that have been flue cured. Examples for bright tobaccos are Chinese Flue-Cured, Flue-Cured Brazil, US Flue-Cured such as Virginia tobacco, Indian Flue-Cured, Flue-Cured from Tanzania or other African Flue Cured. Bright tobacco is characterized by a high sugar to nitrogen ratio. From a sensorial perspective, bright tobacco is a tobacco type which, after curing, is associated with a spicy and lively sensation. Within the context of the present invention, bright tobaccos are tobaccos with a content of reducing sugars of between about 2.5 percent and about 20 percent of dry weight base of the leaf and a total ammonia content of less than about 0.12 percent of dry weight base of the leaf. Reducing sugars comprise for example glucose or fructose. Total ammonia comprises for example ammonia and ammonia salts.

Dark tobaccos are tobaccos with a generally large, dark coloured leaves. Throughout the specification, the term “dark tobacco” is used for tobaccos that have been air cured. Additionally, dark tobaccos may be fermented. Tobaccos that are used mainly for chewing, snuff, cigar, and pipe blends are also included in this category. Typically, these dark tobaccos are air cured and possibly fermented. From a sensorial perspective, dark tobacco is a tobacco type which, after curing, is associated with a smoky, dark cigar type sensation. Dark tobacco is characterized by a low sugar to nitrogen ratio. Examples for dark tobacco are Burley Malawi or other African Burley, Dark Cured Brazil Galpao, Sun Cured or Air Cured Indonesian Kasturi. According to the invention, dark tobaccos are tobaccos with a content of reducing sugars of less than about 5 percent of dry weight base of the leaf and a total ammonia content of up to about 0.5 percent of dry weight base of the leaf.

Aromatic tobaccos are tobaccos that often have small, light coloured leaves. Throughout the specification, the term “aromatic tobacco” is used for other tobaccos that have a high aromatic content, e.g. of essential oils. From a sensorial perspective, aromatic tobacco is a tobacco type which, after curing, is associated with spicy and aromatic sensation. Example for aromatic tobaccos are Greek Oriental, Oriental Turkey, semi-oriental tobacco but also Fire Cured, US Burley, such as Perique, Rustica, US Burley or Meriland. Filler tobacco is not a specific tobacco type, but it includes tobacco types which are mostly used to complement the other tobacco types used in the blend and do not bring a specific characteristic aroma direction to the final product. Examples for filler tobaccos are stems, midrib or stalks of other tobacco types. A specific example may be flue cured stems of Flue Cure Brazil lower stalk.

The cut filler suitable to be used with the present invention generally may resemble cut filler used for conventional smoking articles. The cut width of the cut filler preferably is between 0.3 millimetres and 2.0 millimetres, more preferably, the cut width of the cut filler is between 0.5 millimetres and 1.2 millimetres and most preferably, the cut width of the cut filler is between 0.6 millimetres and 0.9 millimetres. The cut width may play a role in the distribution of heat inside the aerosol-generating element. Also, the cut width may play a role in the resistance to draw (RTD) of the article. Further, the cut width may impact the overall density of the aerosol-generating substrate as a whole.

The strand length of the cut-filler is to some extent a random value as the length of the strands will depend on the overall size of the object that the strand is cut off from. Nevertheless, by conditioning the material before cutting, for example by controlling the moisture content and the overall subtlety of the material, longer strands can be cut. Preferably, the strands have a length of between about 10 millimetres and about 40 millimetres before the strands are collated to form the aerosol-generating element. Obviously, if the strands are arranged in an aerosol-generating element in a longitudinal extension where the longitudinal extension of the section is below 40 millimetres, the final aerosol-generating element may comprise strands that are on average shorter than the initial strand length. Preferably, the strand length of the cut-filler is such that between about 20 percent and 60 percent of the strands extend along the full length of the aerosol-generating element. This prevents the strands from dislodging easily from the aerosol-generating element.

The first aerosol-generating substrate may comprise any amount of cut filler. For example, the first aerosol-generating substrate may comprise at least 80 milligrams of cut filler, at least 100 milligrams of cut filler, at least 150 milligrams of cut filler, at least about 170 milligrams of cut filler.

The first aerosol-generating substrate may comprise no more than 400 milligrams of cut filler. For example, the first aerosol-generating substrate may comprise no more than 300 milligrams of cut filler, no more than 250 milligrams of cut filler, or no more than 220 milligrams of cut filler.

The first aerosol-generating substrate may comprise between 80 milligrams and 400 milligrams of cut filler. For example, the first aerosol-generating substrate may comprise between 100 milligrams and 300 milligrams of cut filler, between 150 milligrams and 250 milligrams of cut filler, or between 170 milligrams and 220 milligrams of cut filler.

Preferably, the first aerosol-generating substrate may comprise about 200 milligrams of cut filler. This amount of cut filler typically allows for sufficient material for the formation of an aerosol. Additionally, in the light of the aforementioned constraints on diameter and size, this allows for a balanced density of the aerosol-generating element between energy uptake, RTD and fluid passageways within the aerosol-generating element where the aerosol-generating substrate comprises plant material.

The first aerosol-generating substrate may comprise at least one of shredded tobacco material, cast leaf tobacco material, homogenised tobacco material, tobacco cut filler, or reconstituted tobacco material.

The first aerosol-generating substrate may comprise at least one aerosol former.

Where the first aerosol-generating substrate comprises cut filler, the cut filler may be soaked with aerosol former. Soaking the cut filler can be done by spraying or by other suitable application methods. The aerosol former may be applied to the blend during preparation of the cut filler. For example, the aerosol former may be applied to the blend in the direct conditioning casing cylinder (DCCC). Conventional machinery can be used for applying an aerosol former to the cut filler. The aerosol former may be any suitable known compound or mixture of compounds that, in use, facilitates formation of a dense and stable aerosol. The aerosol former may be facilitating that the aerosol is substantially resistant to thermal degradation at temperatures typically applied during use of the aerosol-generating article. Suitable aerosol formers are for example to: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof.

Preferably, the aerosol former comprises one or more of glycerine and propylene glycol. The aerosol former may consist of glycerine or propylene glycol or of a combination of glycerine and propylene glycol.

The first aerosol-generating substrate may comprise any amount of aerosol former. For example, the aerosol-generating substrate may comprise at least 5 weight percent aerosol former, at least 6 weight percent aerosol former, at least 8 weight percent aerosol former, or at least 10 weight percent aerosol former.

The first aerosol-generating substrate may comprise no more than 20 percent aerosol former. For example, the aerosol-generating substrate may comprise no more than 18 percent aerosol former, or no more than 15 percent aerosol former.

The first aerosol-generating substrate may comprise between 5 weight percent aerosol former and 20 percent aerosol former. For example, the first aerosol-generating substrate may comprise between 6 weight percent aerosol former and 18 percent aerosol former, between 8 weight percent aerosol former and 15 percent aerosol former, or between 10 weight percent aerosol former and 15 percent aerosol former.

Preferably, the first aerosol-generating substrate comprises about 13 weight percent aerosol former. The weight percentages of aerosol former are given as a dry weight basis of the cut filler.

The most efficient amount of aerosol former will depend also on the cut filler, whether the cut filler comprises plant lamina or homogenized plant material. For example, among other factors, the type of cut filler will determine to which extent the aerosol-former can facilitate the release of substances from the cut filler.

The second aerosol-generating substrate may comprise a solid aerosol-generating substrate.

The second aerosol-generating substrate may comprise at least one aerosol former.

The second aerosol-generating substrate may comprise nicotine.

The second aerosol-generating substrate may be a solid aerosol-generating substrate contained within the capsule. The solid aerosol-generating substrate may comprise nicotine and an aerosol former but may take a variety of different forms.

The second aerosol-generating substrate may comprise at least 15 percent by weight of aerosol former on a dry weight basis. Preferably, the second aerosol-generating substrate comprises at least 20 percent by weight of aerosol former, on a dry weight basis. More preferably, the second aerosol-generating substrate comprises at least 25 percent by weight of aerosol former, on a dry weight basis. More preferably, the second aerosol-generating substrate comprises at least 30 percent by weight of aerosol former, on a dry weight basis. More preferably, the second aerosol-generating substrate comprises at least 35 percent by weight of aerosol former, on a dry weight basis. More preferably, the second aerosol-generating substrate comprises at least 40 percent by weight of aerosol former, on a dry weight basis. More preferably, the aerosol-generating substrate comprises at least 45 percent by weight of aerosol former, on a dry weight basis. More preferably, the second aerosol-generating substrate comprises at least 50 percent by weight of aerosol former, on a dry weight basis.

Preferably, the second aerosol-generating substrate comprises no more than 80 percent by weight on a dry weight basis. More preferably, the second aerosol-generating substrate comprises no more than 75 percent by weight on a dry weight basis. More preferably, the second aerosol-generating substrate comprises no more than 70 percent by weight on a dry weight basis.

For example, the second aerosol-generating substrate may gave an aerosol former content of between 15 percent by weight and 80 percent by weight, or between 20 percent by weight and 80 percent by weight, or between 25 percent by weight and 80 percent by weight, or between 30 percent by weight and 75 percent by weight, or between 35 percent by weight and 75 percent by weight, or between 40 percent by weight and 70 percent by weight, or between 45 percent by weight and 70 percent by weight, or between 50 percent by weight and 70 percent by weight, on a dry weight basis.

In certain preferred embodiments, the second aerosol former content of the aerosol-generating substrate may be between 40 percent and 80 percent by weight, or between 45 percent and 75 percent by weight, or between 50 percent and 70 percent by weight, on a dry weight basis. In such embodiments, the aerosol former content of the second aerosol-generating substrate is therefore relatively high.

Suitable aerosol formers for inclusion in the second aerosol-generating substrate are known in the art and include, but are not limited to: polyhydric alcohols, such as triethylene glycol, propylene glycol, 1,3-butanediol and glycerol; esters of polyhydric alcohols, such as glycerol mono-, di- or triacetate; and aliphatic esters of mono-, di- or polycarboxylic acids, such as dimethyl dodecanedioate and dimethyl tetradecanedioate.

Preferably, the second aerosol-generating substrate comprises glycerol as aerosol former.

The second aerosol-generating substrate further comprises nicotine. As used herein with reference to the invention, the term “nicotine” is used to describe nicotine, a nicotine base or a nicotine salt. In embodiments in which the second aerosol-generating substrate comprises a nicotine base or a nicotine salt, the amounts of nicotine recited herein are the amount of free base nicotine or amount of protonated nicotine, respectively.

The second aerosol-generating substrate may comprise natural nicotine or synthetic nicotine. The nicotine may comprise one or more nicotine salts. The one or more nicotine salts may be selected from the list consisting of nicotine lactate, nicotine citrate, nicotine pyruvate, nicotine bitartrate, nicotine benzoate, nicotine pectate, nicotine alginate, and nicotine salicylate.

The nicotine may comprise an extract of tobacco.

Preferably, the second aerosol-generating substrate comprises at least 0.5 percent by weight of nicotine on a dry weight basis. More preferably, the second aerosol-generating substrate comprises at least 1 percent by weight of nicotine on a dry weight basis. Even more preferably, the second aerosol-generating substrate comprises at least 2 percent by weight of nicotine on a dry weight basis. In addition, or as an alternative, the second aerosol-generating substrate preferably comprises less than 10 percent by weight of nicotine on a dry weight basis. More preferably, the second aerosol-generating substrate comprises less than 8 percent by weight of nicotine on a dry weight basis. More preferably, the second aerosol-generating substrate comprises less than 6 percent by weight of nicotine on a dry weight basis. po For example, the second aerosol-generating substrate may comprise between 0.5 percent and 10 percent by weight of nicotine, or between 1 percent and 8 percent by weight of nicotine, or between 2 percent and 6 percent by weight of nicotine, on a dry weight basis.

The second aerosol-generating substrate may comprise one or more carboxylic acids. Advantageously, including one or more carboxylic acids in the second aerosol-generating substrate may create a nicotine salt.

The one or more carboxylic acids comprise one or more of lactic acid and levulinic acid. Advantageously, the present inventors have found that lactic acid and levulinic acid are particularly good carboxylic acids for creating nicotine salts.

Preferably, the second aerosol-generating substrate comprises at least 0.5 percent by weight of carboxylic acid, on a dry weight basis. More preferably, the second aerosol-generating substrate comprises at least 1 percent by weight of carboxylic acid, on a dry weight basis. More preferably, the second aerosol-generating substrate comprises at least 2 percent by weight of carboxylic acid, on a dry weight basis.

In addition, or as an alternative, the second aerosol-generating substrate preferably comprises less than 15 percent by weight of carboxylic acid, on a dry weight basis. More preferably, the second aerosol-generating substrate preferably comprises less than 10 percent by weight of carboxylic acid, on a dry weight basis. More preferably, the second aerosol-generating substrate preferably comprises less than 5 percent by weight of carboxylic acid, on a dry weight basis. For example, the aerosol-generating substrate may comprise between 0.5 percent and 15 percent by weight of carboxylic acid, or between 1 percent and 10 percent by weight of carboxylic acid, or between 2 percent and 5 percent by weight of carboxylic acid.

In certain preferred embodiments, the second aerosol-generating substrate is in the form of an aerosol-generating film comprising a cellulosic based film forming agent, nicotine and aerosol former. The aerosol-generating film may further comprise a cellulose based strengthening agent. The aerosol-generating film may further comprise water, preferably 30 percent by weight of less of water.

As used herein, the term “film” is used to describe a solid laminar element having a thickness that is less than the width or length thereof. The film may be self-supporting. In other words, a film may have cohesion and mechanical properties such that the film, even if obtained by casting a film-forming formulation on a support surface, can be separated from the support surface. Alternatively, the film may be disposed on a support or sandwiched between other materials. This may enhance the mechanical stability of the film.

The second aerosol-generating substrate may be provided in any suitable form. Preferably, the capsule contains a plurality of particles of the second aerosol-generating substrate. For example, the capsule may comprise a plurality of beads, pellets, granules, strips, shreds or flakes of the second aerosol-generating substrate.

The second aerosol-generating substrate may comprise a plurality of beads, pellets, granules, strips, shreds or flakes of aerosol-generating material.

The second aerosol-generating substrate may comprise a particulate aerosol-generating material.

In certain embodiments, the maximum dimension of each of the particles is preferably at least 0.05 millimetres, more preferably at least 0.1 millimetres, more preferably at least 0.15 millimetres, more preferably at least 0.2 millimetres, more preferably at least 0.25 millimetres, more preferably at least 0.5 millimetres, more preferably at least 0.75 millimetres, more preferably at least 1 millimetre. Preferably, the maximum dimension of each of the particles is no more than 10 millimetres, more preferably no more than 9 millimetres, more preferably no more than 8 millimetres, more preferably no more than 6 millimetres, more preferably no more than 5 millimetres. Providing relatively large particles within these ranges may be preferable when the capsule wall is provided with holes to form air inlets and outlets, as described below. The relatively large maximum dimension of the particles will then ensure that the particles are not lost through the holes in the capsule wall.

The maximum dimension of a particle corresponds to the largest external diameter of that particles. Where the particles are substantially spherical, the maximum dimension of a particle will correspond to the diameter of that particle.

In such embodiments, the capsule preferably comprises at least 2 particles of the second aerosol-generating substrate, more preferably at least 5 particles of the second aerosol-generating substrate, more preferably at least 10 particles of the aerosol-generating substrate, more preferably at least 20 particles of the second aerosol-generating substrate, more preferably at least 30 particles. The capsule may contain up to 200 particles.

In other embodiments, the second aerosol-generating substrate may be in the form of a powder having a larger number of much smaller particles. For example, in such embodiments, the powder may be formed of particles having a D50 size of between 50 micrometres and 80 micrometres, between 50 micrometres and 75 micrometres, between 55 micrometres and 75 micrometres, between 55 micrometres and 70 micrometres, or between 60 micrometres and 70 micrometres.

As used herein with reference to the present invention, the term “D50 size” refers to the median particle size of the particulate material or powder. The D50 size is the particle size which splits the distribution in half, where half of the particles are larger than the D50 size and half of the particles are smaller than the D50 size. The particle size distribution may be determined by laser diffraction. For example, the particle size distribution may be determined by laser diffraction using a Malvern Mastersizer 3000 laser diffraction particle size analyser in accordance with the manufacturer's instructions.

The powder may be formed of particles having a D95 size of between 80 micrometres and 130 micrometres, between 90 micrometres and 125 micrometres, between 100 micrometres and 120 micrometres, or between 110 micrometres and 120 micrometres.

As used herein with reference to the present invention, the term “D95 size” is the size at which the proportion by mass of particles with sizes below this value is 95 percent.

The powder may be formed of particles having a maximum diameter of between 50 micrometres and 250 micrometres, between 80 micrometres and 225 micrometres, or between 100 micrometres and 125 micrometres.

In embodiments where the capsule contains a plurality of particles, the mass of each particle is preferably at least 0.05 micrograms, more preferably at least 0.1 micrograms, more preferably at least 0.2 micrograms, more preferably at least 0.3 micrograms, more preferably at least 0.4 micrograms, more preferably at least 0.5 micrograms, more preferably at least 0.6 micrograms, more preferably at least 0.7 micrograms, more preferably at least 0.8 micrograms, more preferably at least 0.9 micrograms, more preferably at least 1 microgram, more preferably at least 10 micrograms, more preferably at least 100 micrograms, more preferably at least 200 micrograms, more preferably at least 500 micrograms, more preferably at least 1 milligram. The mass of each particle is preferably no more than 600 milligrams, more preferably no more than 500 milligrams, more preferably no more than 400 milligrams, more preferably no more than 300 milligrams, more preferably no more than 200 milligrams, more preferably no more than 100 milligrams, more preferably no more than 50 milligrams, more preferably no more than 10 milligrams.

Alternatively, the second aerosol-generating substrate may be in the form of one or more sheets. As used herein with reference to the invention, the term “sheet” describes a laminar element having a width and length substantially greater than the thickness thereof.

The one or more sheets as described herein may have been one or more of crimped, folded, gathered and pleated. The one or more sheets may be cut into strands.

Alternatively, the aerosol-generating element may comprise an upstream capsule. The first aerosol-generating substrate may be contained within the upstream capsule. The upstream capsule may comprise any of the features of the capsule described above, which may also be referred to as the downstream capsule.

Where the first aerosol-generating element may comprise an upstream capsule, it is preferably for the hollow tubular element to extend to substantially the upstream end of the aerosol-generating article. Preferably, the upstream capsule has the same diameter as the downstream capsule. In this way, both the upstream and downstream capsule may be provided within the hollow tubular element.

Where the first aerosol-generating substrate is contained in an upstream capsule, the first aerosol-generating substrate may comprise any of the features or components described above in relation to the second aerosol-generating substrate.

Where the first aerosol-generating substrate is contained in an upstream capsule, the aerosol-generating article may further comprise at least one aerosol-generating element stop protruding from the inner surface of the hollow tubular element to prevent the aerosol-generating element from moving further downstream than the at least one aerosol-generating element stop.

The features of the at least one capsule downstream stop described above may be equally applicable to the at least one aerosol-generating element stop.

According to a second aspect of the present invention, there is provided an aerosol-generating system comprising an aerosol-generating article according to the first aspect of the present invention, and an aerosol-generating device. The aerosol-generating device comprises a heating chamber for receiving the aerosol-generating article and a heating element provided in the heating chamber or about the periphery of the heating chamber.

The aerosol-generating device may comprise an upstream end and a downstream end. The aerosol-generating device may comprise a body. The body or housing of the aerosol-generating device may define a heating chamber for removably receiving the aerosol-generating article at the downstream end of the device. The aerosol-generating device comprises a heating element or heater for heating the aerosol-generating substrate when the aerosol-generating article is received within the heating chamber.

The heating chamber may extend between an upstream end and a downstream end. The upstream end of the heating chamber may be a closed end and the downstream end of the heating chamber may be an open end. An aerosol-generating article may be inserted into the heating chamber, via the open end of the heating chamber. The heating chamber may be cylindrical in shape so as to conform to the same shape of an aerosol-generating article.

The expression “received within” may refer to the fact that a component or element is fully or partially received within another component or element. For example, the expression “aerosol-generating article is received within the heating chamber” refers to the aerosol-generating article being fully or partially received within the heating chamber of the aerosol-generating article. When the aerosol-generating article is received within the heating chamber, the aerosol-generating article may abut the upstream end of the heating chamber. When the aerosol-generating article is received within the heating chamber, the aerosol-generating article may be in substantial proximity to the upstream end of the heating chamber. The upstream end of the heating chamber may be defined by an end-wall.

The length of the heating chamber may be between 15 millimetres and 80 millimetres, or between 20 millimetres and 70 millimetres, or between 25 millimetres and 60 millimetres, or between 25 millimetres and 50 millimetres.

The length of the heating chamber may be between 25 millimetres and 29 millimetres, or between 26 millimetres and 29 millimetres, or between 27 millimetres or 28 millimetres.

When the aerosol-generating article is received within the heating chamber, the aerosol-generating element is preferably fully within the device cavity, in order to optimise the heating of the first aerosol-generating substrate within the aerosol-generating element. The length of the device cavity is therefore preferably greater than the length of the aerosol-generating element.

A diameter of the heating chamber may be between 4 millimetres and 10 millimetres. A diameter of the heating chamber may be between 5 millimetres and 9 millimetres. A diameter of the heating chamber may be between 6 millimetres and 8 millimetres. A diameter of the heating chamber may be between 6 millimetres and 7 millimetres.

A diameter of the heating chamber may be substantially the same as or greater than a diameter of the aerosol-generating article. A diameter of the heating chamber may be the same as a diameter of the aerosol-generating article in order to establish a tight fit with the aerosol-generating article.

The heating chamber may be configured to establish a tight fit with an aerosol-generating article received within the heating chamber. Tight fit may refer to a snug fit. The aerosol-generating device may comprise a peripheral wall. Such a peripheral wall may define the heating chamber. The peripheral wall defining the heating chamber may be configured to engage with an aerosol-generating article received within the heating chamber in a tight fit manner, so that there is substantially no gap or empty space between the peripheral wall defining the heating chamber and the aerosol-generating article when received within the device.

Such a tight fit may establish an airtight fit or configuration between the heating chamber and an aerosol-generating article received therein.

With such an airtight configuration, there would be substantially no gap or empty space between the peripheral wall defining the heating chamber and the aerosol-generating article for air to flow through.

The tight fit with an aerosol-generating article may be established along the entire length of the heating chamber or along a portion of the length of the heating chamber.

The aerosol-generating device may comprise an air-flow channel extending between a channel inlet and a channel outlet. The air-flow channel may be configured to establish a fluid communication between the interior of the heating chamber and the exterior of the aerosol-generating device. The air-flow channel of the aerosol-generating device may be defined within the housing of the aerosol-generating device to enable fluid communication between the interior of the heating chamber and the exterior of the aerosol-generating device. When an aerosol-generating article is received within the heating chamber, the air-flow channel may be configured to provide air flow into the article in order to deliver generated aerosol to a user drawing from the downstream end of the article.

The air-flow channel of the aerosol-generating device may be defined within, or by, the peripheral wall of the housing of the aerosol-generating device. In other words, the air-flow channel of the aerosol-generating device may be defined within the thickness of the peripheral wall or by the inner surface of the peripheral wall, or a combination of both. The air-flow channel may partially be defined by the inner surface of the peripheral wall and may be partially defined within the thickness of the peripheral wall. The inner surface of the peripheral wall defines a peripheral boundary of the device cavity.

The air-flow channel of the aerosol-generating device may extend from an inlet located at the downstream end of the aerosol-generating device to an outlet located away from the downstream end of the device. The air-flow channel may extend along a direction parallel to the longitudinal axis of the aerosol-generating device.

The heater may be any suitable type of heater. Preferably, in the present invention, the heater is an external heater which heats the aerosol-generating element. Such an external heater may circumscribe the aerosol-generating article when inserted in or received within the aerosol-generating device.

Alternatively, the heater may be an elongate heater blade that is adapted to be inserted into the aerosol-generating element in order to internally heat the first aerosol-generating substrate.

The heater may comprise at least one heating element. The at least one heating element may be any suitable type of heating element. In some embodiments, the device comprises only one heating element. In some embodiments, the device comprises a plurality of heating elements.

The heating element may be a resistive heating element.

Suitable materials for forming the resistive heating element include but are not limited to: semiconductors such as doped ceramics, electrically ‘conductive’ ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium—titanium—zirconium-, hafnium-, niobium-, molybdenum-, tantalum-, tungsten-, tin-, gallium-, manganese- and iron-containing alloys, and super-alloys based on nickel, iron, cobalt, stainless steel, Timetal® and iron-manganese-aluminium based alloys.

In some embodiments, the resistive heating element comprises one or more stamped portions of electrically resistive material, such as stainless steel. Alternatively, the at least one resistive heating element may comprise a heating wire or filament, for example a Ni—Cr (Nickel—Chromium), platinum, tungsten or alloy wire.

In some embodiments, the heating element comprises an electrically insulating substrate, wherein the at least one resistive heating element is provided on the electrically insulating substrate.

The electrically insulating substrate may comprise any suitable material. For example, the electrically insulating substrate may comprise one or more of: paper, glass, ceramic, anodized metal, coated metal, and Polyimide. The ceramic may comprise mica, Alumina (Al₂O₃) or Zirconia (ZrO₂). Preferably, the electrically insulating substrate has a thermal conductivity of less than or equal to about 40 Watts per metre Kelvin, preferably less than or equal to about 20 Watts per metre Kelvin and ideally less than or equal to about 2 Watts per metre Kelvin.

The heater may comprise a heating element comprising a rigid electrically insulating substrate with one or more electrically conductive tracks or wire disposed on its surface. The size and shape of the electrically insulating substrate may allow it to be inserted directly into an aerosol-generating substrate. If the electrically insulating substrate is not sufficiently rigid, the heating element may comprise a further reinforcement means. A current may be passed through the one or more electrically conductive tracks to heat the heating element and the aerosol-generating substrate.

In some embodiments, the heater comprises an inductive heating arrangement. The inductive heating arrangement may comprise an inductor coil and a power supply configured to provide high frequency oscillating current to the inductor coil. As used herein, a high frequency oscillating current means an oscillating current having a frequency of between about 500 kHz and about 30 MHz. The heater may advantageously comprise a DC/AC inverter for converting a DC current supplied by a DC power supply to the alternating current. The inductor coil may be arranged to generate a high frequency oscillating electromagnetic field on receiving a high frequency oscillating current from the power supply. The inductor coil may be arranged to generate a high frequency oscillating electromagnetic field in the device cavity. In some embodiments, the inductor coil may substantially circumscribe the device cavity. The inductor coil may extend at least partially along the length of the device cavity.

The provision of heater comprising an inductive heating arrangement may advantageously be used in combination with an aerosol-generating article which comprises a susceptor element as described above.

The heater may comprise an inductive heating element. The inductive heating element may be a susceptor element. A susceptor element may be arranged such that, when the aerosol-generating article is received in the cavity of the aerosol-generating device, the oscillating electromagnetic field generated by the inductor coil induces a current in the susceptor element, causing the susceptor element to heat up. In these embodiments, the aerosol-generating device is preferably capable of generating a fluctuating electromagnetic field having a magnetic field strength (H-field strength) of between 1 and 5 kilo amperes per metre (kA m), preferably between 2 and 3 kA/m, for example about 2.5 kA/m. The electrically-operated aerosol-generating device is preferably capable of generating a fluctuating electromagnetic field having a frequency of between 1 and 30 MHz, for example between 1 and 10 MHz, for example between 5 and 7 MHz.

In these embodiments, the susceptor element is preferably located in contact with the first aerosol-generating substrate. In some embodiments, a susceptor element is located in the aerosol-generating device. In these embodiments, the susceptor element may be located in the cavity. The aerosol-generating device may comprise only one susceptor element. The aerosol-generating device may comprise a plurality of susceptor elements. In some embodiments, the susceptor element is preferably arranged to heat the outer surface of the aerosol-generating substrate.

The susceptor element may comprise any suitable susceptor element.

In some embodiments the aerosol-generating device may comprise at least one resistive heating element and at least one inductive heating element. In some embodiments the aerosol-generating device may comprise a combination of resistive heating elements and inductive heating elements.

During use, the heater may be controlled to operate within a defined operating temperature range, below a maximum operating temperature. An operating temperature range between about 150 degrees Celsius and about 300 degrees Celsius in the heating chamber (or device cavity) is preferable. The operating temperature range of the heater may be between about 150 degrees Celsius and about 250 degrees Celsius.

In use, the system may be configured to heat the aerosol-generating element and the capsule such that the first aerosol-generating substrate and the second aerosol-generating substrate are heated. The system may be configured to heat the first aerosol-generating substrate to a first temperature. The system may be configured to heat the second aerosol-generating substrate to a second temperature. The first temperature may be higher than the second temperature. For example, the first temperature may be at least 5 degrees Celsius, at least 10 degrees Celsius, at least 20 degrees Celsius, at least 30 degrees Celsius, or at least 50 degrees Celsius higher than the second temperature.

The first and second temperatures may both be higher than ambient temperature. The first and second temperatures may both be higher than room temperature. The first and second temperatures may both be higher than 20 degrees Celsius, 30 degrees Celsius, 35 degrees Celsius, 40 degrees Celsius, 50 degrees Celsius, 60 degrees Celsius, or 100 degrees Celsius. The second temperature may be higher than ambient temperature. For example, the second temperature may be higher than 20 degrees Celsius, 30 degrees Celsius, 35 degrees Celsius, 40 degrees Celsius, 50 degrees Celsius, 60 degrees Celsius, or 100 degrees Celsius.

The aerosol-generating device may comprise a power supply. The power supply may be a DC power supply. In some embodiments, the power supply is a battery. The power supply may be a nickel-metal hydride battery, a nickel cadmium battery, or a lithium based battery, for example a lithium—cobalt, a lithium—iron—phosphate or a lithium-polymer battery. However, in some embodiments the power supply may be another form of charge storage device, such as a capacitor. The power supply may require recharging and may have a capacity that allows for the storage of enough energy for one or more user operations, for example one or more aerosol-generating experiences.

The aerosol-generating device may comprise a piercing device for piercing the capsule when the aerosol-generating article is inserted into the device cavity. As described above, the piercing of the capsule may be necessary in order to establish one or more airflow pathways through the capsule.

According to a third aspect of the present invention, there is provided a method for operating the aerosol generating system. The method comprises steps of inserting the aerosol-generating article into the heating chamber of the aerosol-generating device, and activating the heating element to heat the aerosol-generating article. During heating of the aerosol-generating article, the first aerosol-generating substrate and the second aerosol-generating substrate may be heated. The first aerosol-generating substrate may be heated to a first temperature. The second aerosol-generating substrate may be heated to a second temperature. The first temperature may be higher than the second temperature. For example, the first temperature may be at least 5 degrees Celsius, at least 10 degrees Celsius, at least 20 degrees Celsius, at least 30 degrees Celsius, or at least 50 degrees Celsius higher than the second temperature.

The first and second temperatures may both be higher than ambient temperature. The first and second temperatures may both be higher than room temperature. The first and second temperatures may both be higher than 20 degrees Celsius, 30 degrees Celsius, 35 degrees Celsius, 40 degrees Celsius, 50 degrees Celsius, 60 degrees Celsius, or 100 degrees Celsius. The second temperature may be higher than ambient temperature. For example, the second temperature may be higher than 20 degrees Celsius, 30 degrees Celsius, 35 degrees Celsius, 40 degrees Celsius, 50 degrees Celsius, 60 degrees Celsius, or 100 degrees Celsius.

Below, there is provided a non-exhaustive list of non-limiting examples. Any one or more of the features of these examples may be combined with any one or more features of another example, embodiment, or aspect described herein.
Example 1: An aerosol-generating article for generating an inhalable aerosol upon heating, the article comprising: an aerosol-generating element comprising a first aerosol-generating substrate, and a capsule located downstream of the aerosol-generating element, the capsule containing a second aerosol-generating substrate, the capsule comprising at least one capsule air inlet located at the upstream end of the capsule, and at least one capsule air outlet located at the downstream end of the capsule.
Example 1a: An aerosol-generating article for generating an inhalable aerosol upon heating, the article comprising: an aerosol-generating element comprising a first aerosol-generating substrate, and a capsule located downstream of the aerosol-generating element, the capsule containing a second aerosol-generating substrate, the second aerosol-generating substrate comprising nicotine, the capsule comprising at least one capsule air inlet located at the upstream end of the capsule, and at least one capsule air outlet located at the downstream end of the capsule, wherein the downstream end of the capsule is at least 10 millimetres from the downstream end of the aerosol-generating article.
Example 2: An aerosol-generating article according to Example 1 or Example 1a, wherein the aerosol-generating element has a length of at least 5 mm.
Example 3: An aerosol-generating article according to any preceding Example, wherein the capsule has a length of at least 10 mm.
Example 4: An aerosol-generating article according to any preceding Example, wherein the ratio of the length of the capsule to the length of the aerosol-generating element is at least 1.
Example 5: An aerosol-generating article according to any preceding Example, wherein the ratio of the number of capsule air inlets to the number of capsule air outlets is at least 1.
Example 6: An aerosol-generating article according to any preceding Example, further comprising a hollow tubular element located downstream of the aerosol-generating element, the capsule being located in the hollow tubular element.
Example 7: An aerosol-generating article according to Example 6, wherein an upstream end of the hollow tubular element abuts a downstream end of the aerosol-generating element.
Example 8: An aerosol-generating article according to Example 6 or Example 7, further comprising a wrapper circumscribing at least a downstream portion of the aerosol-generating element and an upstream portion of the hollow tubular element.
Example 9: An aerosol-generating article according to any one of Examples 6 to 8, wherein the external diameter of the capsule is approximately the same as the inner diameter of the hollow tubular element such that air is unable to pass from the upstream end of the hollow tubular element to the downstream end of the hollow tubular element without passing through the capsule.
Example 10: An aerosol-generating article according to any preceding Example, further comprising a heat conducting element to transfer heat from the aerosol-generating element to the capsule.
Example 11: An aerosol-generating article according to Example 9, wherein the heat conducting element comprises a portion of the wrapper formed from a heat conducting material.
Example 12: An aerosol-generating article according to Example 9, wherein the heat conducting element comprises a rod of heat conductive material extending from the aerosol-generating element to the capsule.
Example 13: An aerosol-generating article according to any preceding Example, wherein the first aerosol-generating substrate and the second aerosol-generating substrate are configured to generate a first and second aerosol respectively when heated.
Example 14: An aerosol-generating article according to Example 13, wherein the temperature at which the second aerosol-generating substrate generates an aerosol is lower than the temperature at which the first aerosol-generating substrate generates an aerosol.
Example 15: An aerosol-generating article according to Example 13, wherein the first aerosol-generating substrate generates an aerosol when heated above a first temperature, and wherein the second aerosol-generating substrate generates an aerosol when heated above a second temperature, the first temperature being higher than the first temperature.
Example 16: An aerosol-generating article according to Example 15, wherein the first and second temperatures are higher than 20 degrees Celsius.
Example 17: An aerosol-generating article according to any preceding Example, further comprising a downstream filter segment located downstream of the capsule, the downstream filter segment comprising filter material.
Example 18: An aerosol-generating article according to any preceding Example, wherein the aerosol-generating element further comprises a susceptor element.
Example 19: An aerosol-generating article according to Example 18, wherein the susceptor element extends the full length of the aerosol-generating element.
Example 20: An aerosol-generating article according to any preceding Example, wherein the first aerosol-generating substrate comprises tobacco.
Example 21: An aerosol-generating article according to Example 20, wherein the first aerosol-generating substrate comprises at least one of shredded tobacco material, cast leaf tobacco material, homogenised tobacco material, tobacco cut filler, or reconstituted tobacco material.
Example 22: An aerosol-generating article according to any preceding Example, wherein the first aerosol-generating substrate comprises at least one aerosol former.
Example 23: An aerosol-generating article according to any preceding Example, wherein the second aerosol-generating substrate comprises a solid aerosol-generating substrate.
Example 24: An aerosol-generating article according to any preceding Example, wherein the second aerosol-generating substrate comprises a particulate aerosol-generating material.
Example 25: An aerosol-generating article according to any preceding Example, wherein the second aerosol-generating substrate comprises a plurality of beads, pellets, granules, strips, shreds or flakes of aerosol-generating material.
Example 26: An aerosol-generating article according to any preceding Example, wherein the second aerosol-generating substrate comprises at least one aerosol former.
Example 27: An aerosol-generating article according to any preceding Example, wherein the second aerosol-generating substrate comprises nicotine.
Example 28: An aerosol-generating article according to any preceding Example, wherein the hollow tubular element comprises a first ventilation zone provided downstream of the downstream end of the aerosol-generating element but upstream of the upstream end of the capsule.
Example 29: An aerosol-generating article according to any preceding Example, wherein the hollow tubular element further comprises a second ventilation zone provided downstream of the downstream end of the capsule.
Example 30: An aerosol-generating article according to any preceding Example, further comprising at least one capsule downstream stop protruding from the inner surface of the hollow tubular element to prevent the capsule from moving further downstream than the at least one capsule downstream stop.
Example 31: An aerosol-generating article according to any preceding Example, further comprising at least one capsule upstream stop protruding from the inner surface of the hollow tubular element to prevent the capsule from moving further upstream than the at least one capsule upstream stop.
Example 32: An aerosol-generating system comprising: an aerosol-generating article according to any one of Examples 1 to 27; and an aerosol-generating device comprising a heating chamber for receiving the aerosol-generating article and a heating element provided in the heating chamber or about the periphery of the heating chamber.
Example 33: An aerosol-generating system according to Example 32, wherein the system is configured to heat the first aerosol-generating substrate to a first temperature, and wherein the system is configured to heat the second aerosol-generating substrate to a second temperature.
Example 34: An aerosol-generating system according to Example 33, wherein the first temperature is higher than the second temperature.
Example 35: An aerosol-generating system according to Example 33 or Example 34, wherein the first and second temperatures are higher than 20 degrees Celsius.
Example 36: A method for operating the aerosol-generating system according to any one of Example 33 to Example 35, the method comprising steps of inserting the aerosol-generating article into the heating chamber of the aerosol-generating device, and activating the heating element to heat the aerosol-generating article.
Example 37: A method according to Example 36, wherein the first aerosol-generating substrate is heated to a first temperature, and wherein the second aerosol-generating substrate is heated to a second temperature.
Example 38: An aerosol-generating system according to Example 37, wherein the first temperature is higher than the second temperature.
Example 39: An aerosol-generating system according to Example 37 or Example 38, wherein the first and second temperatures are higher than 20 degrees Celsius.

In the following, the invention will be further described with reference to the drawings of the accompanying Figures, wherein:

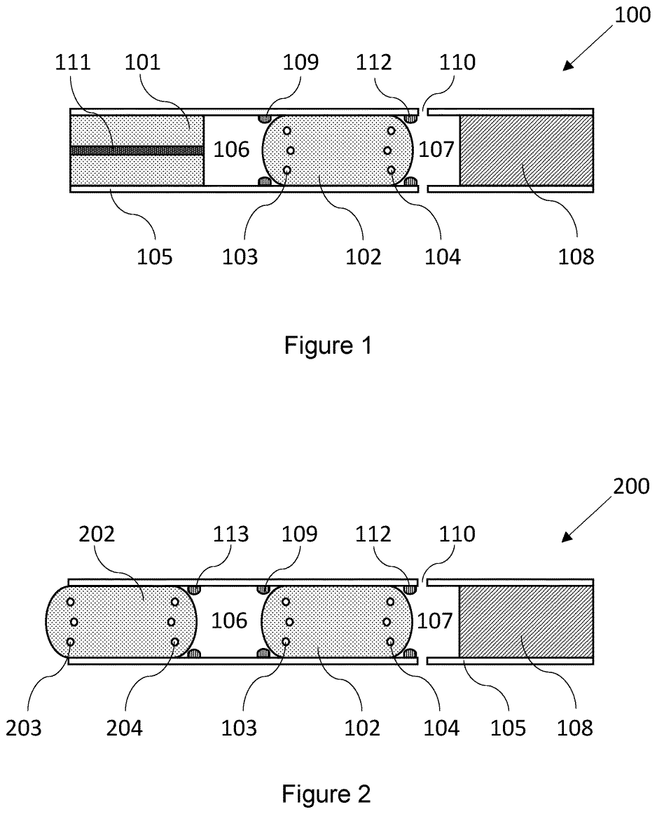

FIG. 1 shows a schematic side sectional view of an aerosol-generating article in accordance with a first embodiment of the invention;

FIG. 2 shows a schematic side sectional view of an aerosol-generating article in accordance with a second embodiment of the invention;

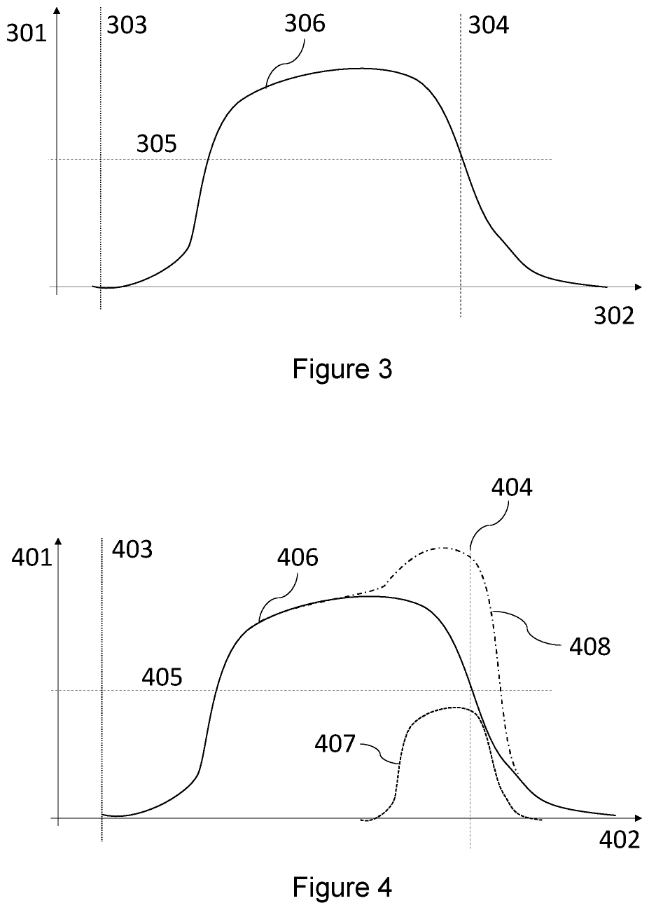

FIG. 3 is a graph showing how the level of aerosol delivered varies with time during the use of an aerosol-generating system of the prior art;

FIG. 4 is a graph showing how the level of aerosol delivered varies with time during the use of an aerosol-generating system according to the present invention;

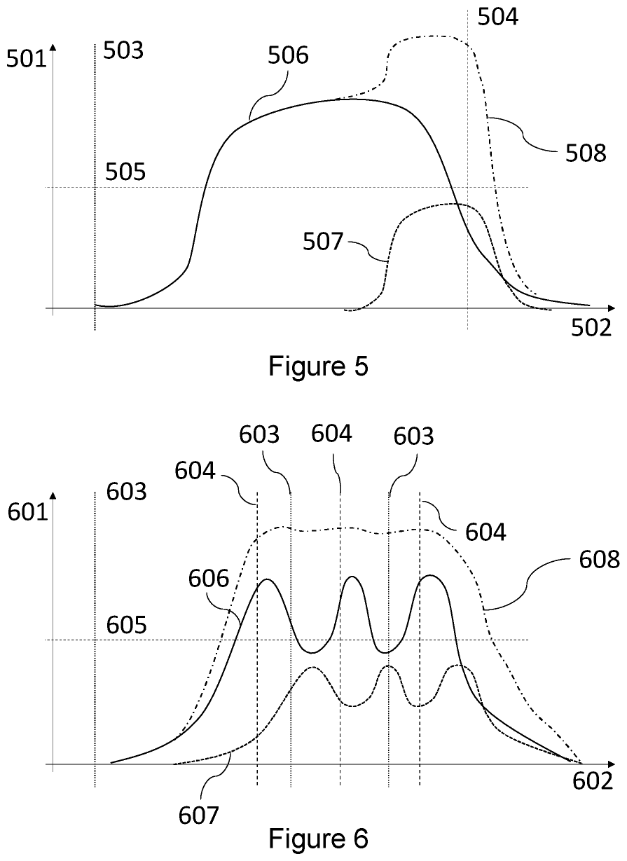

FIG. 5 is a graph showing how the level of aerosol delivered varies with time during the use of an aerosol-generating system according to the present invention;

FIG. 6 is a graph showing how the level of aerosol delivered varies with time during the use of an aerosol-generating system according to the present invention;

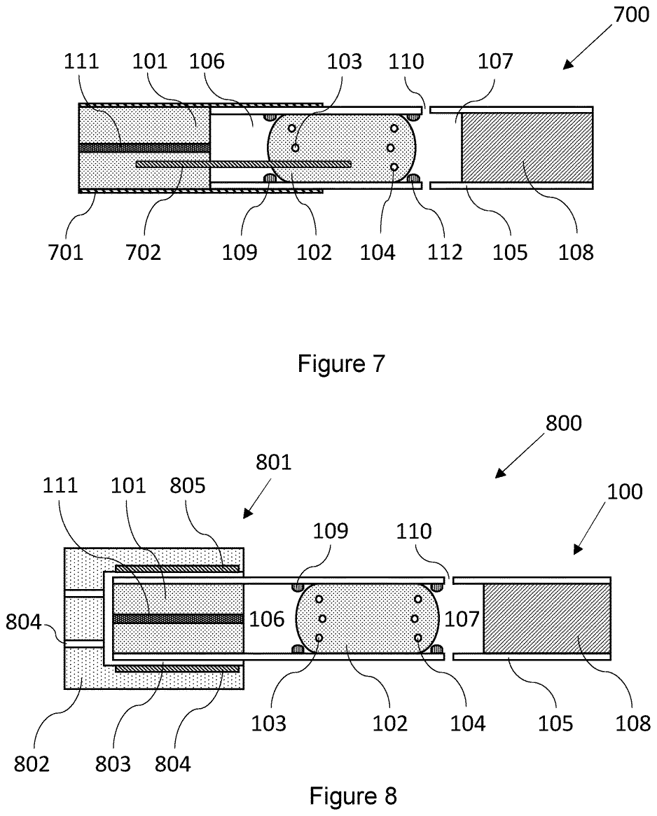

FIG. 7 shows a schematic side sectional view of an aerosol-generating article in accordance with a third embodiment of the invention;

FIG. 8 shows a schematic side sectional view of an aerosol-generating system in accordance with the present invention.

The aerosol-generating article 100 shown in FIG. 1 comprises an aerosol-generating element 101 and a capsule 102 located downstream of the aerosol-generating element 101. The aerosol-generating element 101 comprises a first aerosol-generating substrate. The aerosol-generating article 100 further comprises a hollow tubular element 105 which extends from the upstream end of the aerosol-generating article 100 to the downstream end of the aerosol-generating article 100. The aerosol-generating element 101 and a capsule 102 are mounted inside the hollow tubular element 105. The aerosol-generating element 101 is mounted at the upstream end of the aerosol-generating article 101. The capsule 102 is mounted downstream of the downstream end of the aerosol-generating element 101.

The aerosol-generating article 100 further comprises a downstream filter segment 108 mounted inside the hollow tubular element 105 at the downstream end of the aerosol-generating article 100. The downstream filter segment 108 is formed from cellulose acetate tow. The downstream filter segment 108 has a length of 10 millimetres and a diameter of 6.7 millimetres.

The hollow tubular element 105 is formed from cardboard and has a cylindrical shape extending from an upstream end to a downstream end. The hollow tubular element 105 has a constant outer diameter of about 7.2 millimetres and a constant inner diameter of about 6.7 millimetres. The hollow tubular element 105 therefore has a wall thickness of about 0.25 millimetres. The hollow tubular element 105 has a length of about 40 millimetres.

In the embodiment shown in FIG. 1, the first aerosol-generating substrate comprises a solid aerosol-generating substrate comprising tobacco cut filler impregnated with about 12 percent by weight of an aerosol former, such as glycerin. The tobacco cut filler comprises 90 percent by weight of tobacco leaf lamina. The cut width of the tobacco cut filler is about 0.7 millimetres. The aerosol-generating substrate comprises about 130 milligrams of tobacco cut filler. The first aerosol-generating substrate has a density of about 0.28 grams per cubic centimetre. The aerosol-generating element 101 further comprises a susceptor element 111. The susceptor element 111 comprises a length of aluminium material embedded in the first aerosol-generating substrate and extending from the upstream end of the aerosol-generating element to the downstream end of the aerosol-generating element 105.

The aerosol-generating element 101 has a length of about 10 millimetres and an external diameter of about 6.7 millimetres. The external diameter of the aerosol-generating element 101 is therefore similar to the internal diameter of the hollow tubular element 105 such that the aerosol-generating element 101 is retained within the hollow tubular element 105 by means of a friction fit.

The capsule 102 is disposed within a capsule section. The capsule section of the hollow tubular element 105 extends from the downstream end of the aerosol-generating element 101 to the upstream end of the downstream filter segment 108. The capsule 102 is disposed at the centre of the capsule section. The length of the capsule section is greater than the length of the capsule to provide an upstream cavity 106 upstream of the capsule 102 and a downstream cavity 107 downstream of the capsule 102.

The capsule 102 comprises an outer wall formed from air impermeable polymer such as HPMC. The capsule 102 has an elongate, capsule (sphero-cylindrical) shape with a round cross section. The capsule 102 comprises a capsule outer wall defining an internal cavity which contains a plurality of beads of first aerosol-generating substrate (not shown in FIG. 1). The first aerosol-generating substrate comprises nicotine and glycerin as an aerosol former. The capsule outer wall is defined by a cylindrical wall and opposed hemispherical end walls at the upstream and downstream end of the capsule 102. The capsule 102 has a length of about 10 millimetres and an external diameter of about 6.7 millimetres. The external diameter of the capsule 102 is therefore similar to the internal diameter of the hollow tubular element 101 such that the capsule 102 is retained within the hollow tubular element 105 by means of a friction fit.

The capsule 102 has an internal volume of about 600 cubic millimetres and contains about 200 milligrams of the solid aerosol-generating substrate. The capsule 102 therefore contains approximately 0.33 milligrams of aerosol-generating substrate per cubic millimetre of the internal cavity.

The capsule 102 comprises a plurality of capsule air inlets 103 at the upstream end of the capsule 102, on the hemispherical upstream end wall of the capsule 102. The capsule 102 comprises a plurality of capsule air outlets 104 at the downstream end of the capsule 102, on the hemispherical downstream end wall of the capsule 102. The arrangement of the capsule air inlets 103 and capsule air outlets 104 is set out in more detail below.

The hollow tubular element 105 comprises a first ventilation zone to allow external air to enter the aerosol-generating article 100. The first ventilation zone is provided downstream of the downstream end of the capsule 102.

The first ventilation zone comprises 10 ventilation perforations 110 which extend through the hollow tubular element 104. The ventilation perforations 110 are evenly spaced from one-another, and are arranged in a line circumscribing the hollow tubular element 105. The ventilation perforations 110 are all the same size. Each ventilation perforation 110 has a width of 100 micrometres and a length of 600 micrometres. The first ventilation zone provides a ventilation level of at least 20 percent.

The aerosol-generating article 100 further comprises at least one capsule downstream stop 112 protruding from the inner surface of the hollow tubular element 105 to prevent the capsule 102 from moving further downstream than the at least one capsule downstream stop 112. The at least one capsule downstream stop 112 comprises an annular flange attached to and extending from the inner surface of the hollow tubular element 105. The inner diameter of the flange is smaller than the outer diameter of the capsule 102 thereby preventing the capsule 102 from moving further downstream than the stop 112. The at least one capsule downstream stop 112 is located upstream of the ventilation zone.

The aerosol-generating article 100 further comprises at least one capsule upstream stop 109 protruding from the inner surface of the hollow tubular element 105 to prevent the capsule 102 from moving further upstream than the at least one capsule upstream stop 109. The at least one capsule upstream stop 109 comprises an annular flange attached to and extending from the inner surface of the hollow tubular element 105. The inner diameter of the flange is smaller than the outer diameter of the capsule 102 thereby preventing the capsule 102 from moving further upstream than the stop 109.

FIG. 2 shows a second aerosol-generating article 200 in accordance with the present invention. The aerosol-generating article 200 includes many features in common with the aerosol-generating article 100 of FIG. 1. These common features are identified by the same reference numerals.

The second aerosol-generating article 200 differs from the first aerosol-generating article 100 in that the aerosol-generating element 202 of the second aerosol-generating article 200 comprises a capsule. The capsule aerosol-generating element 202 is identical to the capsule 102 and comprises a plurality of air inlets 203 and air outlets 204. The capsule aerosol-generating element 202 contains the first aerosol-generating substrate.

The aerosol-generating article 200 further comprises at least one aerosol-generating element downstream stop 113 protruding from the inner surface of the hollow tubular element 105 to prevent the aerosol-generating element 202 from moving further downstream than the at least one capsule downstream stop 113. The at least one capsule downstream stop 113 comprises an annular flange attached to and extending from the inner surface of the hollow tubular element 105. The inner diameter of the flange is smaller than the outer diameter of the aerosol-generating element 202 thereby preventing the aerosol-generating element 202 from moving further downstream than the stop 113.

FIG. 3 is a graph showing how the quantity of aerosol produced by an aerosol-generating system comprising an aerosol-generating article varies over the use of the aerosol-generating system. The aerosol-generating article used is an aerosol-generating of the prior art and is not in accordance with the present invention. The aerosol-generating article differs from the present invention only in that it does not include a capsule containing a second aerosol-generating substrate. The aerosol-generating element is upstream of a long cavity within the hollow tubular element. A downstream filter segment is disposed downstream of the long cavity.

The graph plots aerosol level 301 against time 302 for the use of a single aerosol-generating article. The heater in the aerosol-generating device is turned on at time 303 and turned off at time 304. Line 305 indicates a minimal concentration level (MCL) of aerosol; an aerosol delivery below the MCL is not considered sufficient for an acceptable user experience.

As can be seen from the plot 306 on the graph, once the heater is initially turned on, the aerosol delivery begins to increase as the heat from the heater generates aerosol from the first aerosol-generating substrate. The aerosol level crosses the MCL and the rate of increase of aerosol begins to decrease. Eventually, despite the heater being turned on, the aerosol delivery level begins to drop. This is because the aerosol-generating substrate becomes depleted. Eventually the aerosol generation level falls below the MCL. At this point, the heater is turned off since it is no longer possible to generate an acceptable aerosol amount from the aerosol-generating substrate. The aerosol-generating substrate then cools and aerosol delivery ends.

FIG. 4 is a graph showing how the quantity of aerosol produced by an aerosol-generating system comprising an aerosol-generating article varies over the use of the aerosol-generating system. The aerosol-generating article used is an aerosol-generating in accordance with the present invention.

The graph plots aerosol level 401 against time 402 for the use of a single aerosol-generating article in the same way as FIG. 3 and similar reference numerals are used to refer to the same features of the graph. In addition, line 406 indicates the aerosol level generated from the first aerosol-generating substrate, line 407 indicates the aerosol level generated from the second aerosol-generating substrate, and line 408 indicates the total aerosol level generated by the aerosol-generating article. As can be seen, the heater is turned on and off at the same points as in FIG. 3. In particular, the heater is turned off when the aerosol delivery from the first aerosol-generating substrate falls below the MCL 405. The aerosol level provided by the first aerosol-generating substrate 406 is the same as the corresponding level in FIG. 3. In addition, once the heater has been on for a while, an aerosol level generated from the second aerosol-generating substrate begins to increase. This is because it takes time for the capsule to reach a sufficient temperature to generate an aerosol from the second aerosol-generating substrate since the capsule is not directly heated. As can be seen, the level of aerosol generated from the second aerosol-generating substrate increases and peaks at about the same point that the level of aerosol generated from the second aerosol-generating substrate begins to drop. As a result, the total aerosol generated increases towards the end of the total aerosol experience. The total aerosol delivery is therefore able to be increased compared to the aerosol delivery of the prior art while maintaining the same heating profile.

FIG. 5 is a graph showing how the quantity of aerosol produced by an aerosol-generating system comprising an aerosol-generating article varies over the use of the aerosol-generating system. The aerosol-generating article used is an aerosol-generating in accordance with the present invention.

The graph plots aerosol level 501 against time 502 for the use of a single aerosol-generating article in the same way as FIG. 4 and similar reference numerals are used to refer to the same features of the graph. The heating profile shown in FIG. 5 differs from that shown in FIGS. 3 and 4 since the point at which the heater is turned off 504 occurs after the aerosol delivery from the first aerosol-generating substrate 506 falls below the MCL 505.

As can be seen, the aerosol delivery profile is similar to that shown in FIG. 4. However, in the FIG. 5 example, the heater continues heating even after the first aerosol-generating substrate is essentially depleted. This is intended to heat the second aerosol-generating substrate which is only heated by convection when warm air passes through the capsule. As can be seen, the result of this is that the second aerosol-generating substrate delvers aerosol for a longer period of time 507. This heating profile is intended to maximise the aerosol delivery from the second aerosol-generating substrate, but may be disadvantageous since it requires heating the first aerosol-generating substrate when it has already fallen below the MCL 505.

FIG. 6 is a graph showing how the quantity of aerosol produced by an aerosol-generating system comprising an aerosol-generating article varies over the use of the aerosol-generating system. The aerosol-generating article used is an aerosol-generating in accordance with the present invention.

The graph plots aerosol level 601 against time 602 for the use of a single aerosol-generating article in the same way as FIG. 5 and similar reference numerals are used to refer to the same features of the graph. The heating profile shown in FIG. 6 differs from that shown in FIGS. 3, 4, and 5 since the heater is turned on and off repetitively. Each point at which the heater is turned on is identified by line 603, and each point at which the heater is turned off is identified by line 604.

As can be seen, the level of aerosol generated by the second aerosol-generating substrate 607 begins to increase later than the level of aerosol generated by the first aerosol-generating substrate as in the case in FIGS. 4 and 5. However, when the heater is then switched off, the level of aerosol generated by the first aerosol-generating substrate falls immediately but the level of aerosol generated by the second aerosol-generating substrate continues to rise. This delay is because the second aerosol-generating substrate is only heated by convection when warm air passes through the capsule. As a result of this alternate switching on and off of the heater, the level of aerosol generated by both the first aerosol-generating substrate and the second aerosol-generating substrate varies over the course of the use of the aerosol-generating article. However, because the second aerosol-generating substrate is not directly heated, the peaks and troughs of the aerosol delivery from the first and second aerosol-generating substrates are out of phase. The advantage of this is that the total aerosol generated by the aerosol-generating substrate 608 is smoothed out despite the repeated switching on and off of the heater.

FIG. 7 shows a third aerosol-generating article 700 in accordance with the present invention. The aerosol-generating article 700 includes many features in common with the aerosol-generating article 100 of FIG. 1. These common features are identified by the same reference numerals.

The third aerosol-generating article 700 differs from the first aerosol-generating article 100 in that the hollow tubular element 105 does not extend to the upstream end of the aerosol-generating article 700. Instead, the hollow tubular element 105 only extends from the downstream end of the aerosol-generating article 700 to the upstream end of the capsule section. The aerosol-generating element 101 is upstream of, and abuts, the upstream end of the hollow tubular element 105. The aerosol-generating element 101 is connected to the hollow tubular element 105 with a wrapper 701 which circumscribing the entire length of the aerosol-generating element 101 and an upstream portion of the hollow tubular element 105.

The third aerosol-generating article 700 further comprises a heat conducting element 702 extending from the downstream end of the aerosol-generating element 101, through the upstream cavity 106, and into the upstream portion of the capsule 102. The heat conducting element 702 comprises a rod of aluminium. The heat conducting element is not aligned with the longitudinal centre of the aerosol-generating article 700.

FIG. 8 shows an aerosol-generating system 800 according to the present invention. The system 800 comprises an aerosol-generating article 100 as described above. The system 800 further comprises an aerosol-generating device 801. The aerosol-generating device 801 comprises a device housing 802. The housing 802 defines a heating chamber 803 for receiving the upstream end of the aerosol-generating article 100. The heating chamber 803 has an inner diameter which substantially corresponds to the outer diameter of the aerosol-generating article 100. The heating chamber 803 has a length of about 30 millimetres.

The aerosol-generating device 801 further comprises a heating element or heater 805 for heating the first aerosol-generating substrate when the aerosol-generating article 100 is received within the heating chamber 803. The heater 805 is an inductor coil which is part of an inductive heating arrangement. The heater 603 is connected to a power supply (not shown), and is controlled using control circuitry (not shown).

The aerosol-generating device 801 further comprises a plurality of device air inlets 804 to allow air to enter the heating chamber 803 of the device 801.

In use, the upstream end of the aerosol-generating article 100 is inserted into the heating chamber 803 of the aerosol-generating device 801. The heater 805 is activated and the inductor coil generates an oscillating electromagnetic field. The electromagnetic field induces a current in the susceptor element 111 which causes it to heat up. The heat from the susceptor element 111 heats up the first aerosol-generating substrate of the aerosol-generating element 101 generating a vapour.

When a pressure drop is applied to the downstream end of the aerosol-generating article 100, ambient air is drawn through the device air inlets 804 and into the upstream end of the aerosol-generating article 100. Here the air becomes entrained with the vapour before it leaves the aerosol-generating element 101 and passes into the upstream cavity 106. When the vapour passes into the upstream cavity 106, it condenses to form an aerosol when then passed into the capsule 102 through the capsule air inlets 103. The warm air and aerosol heat the second aerosol-generating substrate within the capsule 102 generating a second vapour. The mixture of aerosol, vapour and air leaves the capsule 102 through the capsule air outlets 104 and enters the downstream cavity 107. Here the air mixes with ambient air drawn through the ventilation perforations 110 which cools the vapour promoting the nucleation and condensation of an aerosol. The aerosol then passes through the downstream filter segment 108 and out of the downstream end of the aerosol-generating article 100.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1-15. (canceled)

16. An aerosol-generating article for generating an inhalable aerosol upon heating, the aerosol-generating article comprising:
an aerosol-generating element comprising a first aerosol-generating substrate; and
a capsule located downstream of the aerosol-generating element, the capsule containing a second aerosol-generating substrate, the second aerosol-generating substrate comprising nicotine,
the capsule comprising at least one capsule air inlet located at an upstream end of the capsule, and at least one capsule air outlet located at a downstream end of the capsule,
wherein the downstream end of the capsule is at least 10 millimetres from the downstream end of the aerosol-generating article, and
wherein the first aerosol-generating substrate generates an aerosol when heated above a first temperature, and wherein the second aerosol-generating substrate generates an aerosol when heated above a second temperature, the first temperature being higher than the second temperature.

17. The aerosol-generating article according to claim 16, wherein the aerosol-generating element has a length of at least 5 mm.

18. The aerosol-generating article according to claim 16, wherein the capsule has a length of at least 10 mm.

19. The aerosol-generating article according to claim 16, wherein a ratio of a length of the capsule to a length of the aerosol-generating element is at least 1.

20. The aerosol-generating article according to claim 16, wherein a ratio of a number of capsule air inlets to a number of capsule air outlets is at least 1.

21. The aerosol-generating article according to claim 16, further comprising a hollow tubular element located downstream of the aerosol-generating element, the capsule being located in the hollow tubular element.

22. The aerosol-generating article according to claim 21, wherein an upstream end of the hollow tubular element abuts a downstream end of the aerosol-generating element.

23. The aerosol-generating article according to claim 21, further comprising a wrapper circumscribing at least a downstream portion of the aerosol-generating element and an upstream portion of the hollow tubular element.

24. The aerosol-generating article according to claim 21, wherein an external diameter of the capsule is approximately the same as an inner diameter of the hollow tubular element such that air is unable to pass from the upstream end of the hollow tubular element to the downstream end of the hollow tubular element without passing through the capsule.

25. The aerosol-generating article according to claim 16, further comprising a heat conducting element to transfer heat from the aerosol-generating element to the capsule.

26. The aerosol-generating article according to claim 25, wherein the heat conducting element comprises a portion of a wrapper formed from a heat conducting material.

27. The aerosol-generating article according to claim 25, wherein the heat conducting element comprises a rod of heat conductive material extending from the aerosol-generating element to the capsule.

28. An aerosol-generating system, comprising:
an aerosol-generating article according to claim 16; and
an aerosol-generating device comprising a heating chamber configured to receive the aerosol-generating article and a heating element provided in the heating chamber or about a periphery of the heating chamber.
